(19) United States
(12) Patent Application Publication
(10) Pub. No.: US 2025/0209744 A1
(43) Pub. Date: Jun. 26, 2025

(54) HYBRID SPATIAL GROUPS IN MULTI-USER COMMUNICATION SESSIONS

(71) Applicant: Apple Inc., Cupertino, CA (US)

(72) Inventors: Patrick PIEMONTE, San Francisco, CA (US); Joseph P. CERRA, San Francisco, CA (US); Connor A. SMITH, San Jose, CA (US); Jacob A. PICCOLO, San Mateo, CA (US); Kevin LEE, San Jose, CA (US)

(21) Appl. No.: 18/978,411

(22) Filed: Dec. 12, 2024

Related U.S. Application Data
(60) Provisional application No. 63/614,486, filed on Dec. 22, 2023.

(51) Int. Cl. G06T 19/00; G06F 3/14; G06T 7/70; H04L 65/1069

(52) U.S. Cl. CPC G06T 19/00; G06F 3/1454; G06T 7/70; H04L 65/1069; G06T 2207/30196; G06T 2219/024

(57) ABSTRACT

Some examples of the disclosure are directed to systems and methods for determining a placement location for an avatar corresponding to a remote user within a multi-user communication session that includes a group of collocated users when initiating the multi-user communication session. In some examples, a first electronic device detects an indication of a request to enter a communication session with a third electronic device, wherein the third electronic device is non-collocated in a first physical environment of the first electronic device. In some examples, in response to detecting the indication, the first electronic device enters the communication session that includes the first electronic device, a second electronic device, and the third electronic device, wherein the second electronic device is collocated in the first physical environment. In some examples, the first electronic device displays a visual representation of a user of the third electronic device in a computer-generated environment.

### CROSS-REFERENCE TO RELATED APPLICATIONS

This application claims the benefit of U.S. Provisional Application No. 63/614,486 filed Dec. 22, 2023, the entire disclosure of which is herein incorporated by reference for all purposes.

### FIELD OF THE DISCLOSURE

This relates generally to systems and methods of establishing multi-user communication sessions in which at least a subset of participants within the multi-user communication sessions is collocated in a physical environment.

### BACKGROUND OF THE DISCLOSURE

Some computer graphical environments provide two-dimensional and/or three-dimensional environments where at least some objects displayed for a user's viewing are virtual and generated by a computer. In some examples, the three-dimensional environments are presented by multiple devices communicating in a multi-user communication session. In some examples, an avatar (e.g., a representation) of each non-collocated user participating in the multi-user communication session (e.g., via the computing devices) is displayed in the three-dimensional environment of the multi-user communication session. In some examples, content can be shared in the three-dimensional environment for viewing and interaction by multiple users participating in the multi-user communication session.

### SUMMARY OF THE DISCLOSURE

Some examples of the disclosure are directed to systems and methods for determining a placement location for an avatar corresponding to a remote user within a multi-user communication session that includes a group of collocated users when initiating the multi-user communication session. In some examples, a method is performed at a first electronic device in communication with one or more displays and one or more input devices, wherein the first electronic device is collocated with a second electronic device in a first physical environment. In some examples, the first electronic device detects an indication of a request to enter a communication session with a third electronic device, wherein the third electronic device is non-collocated in the first physical environment. In some examples, in response to detecting the indication, the first electronic device enters the communication session that includes the first electronic device, the second electronic device, and the third electronic device. In some examples, the first electronic device obtains first data corresponding to a location of a user of the second electronic device relative to a viewpoint of the first electronic device in the first physical environment. In some examples, the first electronic device obtains second data corresponding to an orientation of the second electronic device relative to the viewpoint of the first electronic device in the first physical environment. In some examples, the first electronic device displays, via the one or more displays, a visual representation of a user of the third electronic device at a second location in a computer-generated environment based on the first data and the second data.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIG. 2 illustrates a block diagram of an example architecture for a system according to some examples of the disclosure.

FIG. 3 illustrates an example of a spatial group in a multi-user communication session that includes a first electronic device and a second electronic device according to some examples of the disclosure.

FIGS. 4A-4J illustrate examples of initiating a multi-user communication session that includes collocated and non-collocated users according to some examples of the disclosure.

FIGS. 5A-5E illustrate examples of presenting content within a multi-user communication session that includes collocated and non-collocated users according to some examples of the disclosure.

FIG. 6 illustrates a flow diagram illustrating an example process for establishing a multi-user communication session among a plurality of electronic devices in which at least a subset of the plurality of electronic device are non-collocated according to some examples of the disclosure.

### DETAILED DESCRIPTION

Some examples of the disclosure are directed to systems and methods for determining a placement location for an avatar corresponding to a remote user within a multi-user communication session that includes a group of collocated users when initiating the multi-user communication session. In some examples, a method is performed at a first electronic device in communication with one or more displays and one or more input devices, wherein the first electronic device is collocated with a second electronic device in a first physical environment. In some examples, the first electronic device detects an indication of a request to enter a communication session with a third electronic device, wherein the third electronic device is non-collocated in the first physical environment. In some examples, in response to detecting the indication, the first electronic device enters the communication session that includes the first electronic device, the second electronic device, and the third electronic device. In some examples, the first electronic device obtains first data corresponding to a location of a user of the second electronic device relative to a viewpoint of the first electronic device in the first physical environment. In some examples, the first electronic device obtains second data corresponding to an orientation of the second electronic device relative to the viewpoint of the first electronic device in the first physical environment. In some examples, the first electronic device displays, via the one or more displays, a visual representation of a user of the third electronic device at a second location in a computer-generated environment based on the first data and the second data.

As used herein, a spatial group corresponds to a group or number of participants (e.g., users) in a multi-user communication session. In some examples, a spatial group in the multi-user communication session has a spatial arrangement that dictates locations of users and content that are located in the spatial group. In some examples, users in the same spatial group within the multi-user communication session experience spatial truth according to the spatial arrangement of the spatial group. In some examples, when the user of the first electronic device is in a first spatial group and the user of the second electronic device is in a second spatial group in the multi-user communication session, the users experience spatial truth that is localized to their respective spatial groups. In some examples, while the user of the first electronic device and the user of the second electronic device are grouped into separate spatial groups within the multi-user communication session, if the first electronic device and the second electronic device return to the same operating state, the user of the first electronic device and the user of the second electronic device are regrouped into the same spatial group within the multi-user communication session.

As used herein, a hybrid spatial group corresponds to a group or number of participants (e.g., users) in a multi-user communication session in which at least a subset of the participants is non-collocated in a physical environment. For example, as described via one or more examples in this disclosure, a hybrid spatial group includes at least two participants who are collocated in a first physical environment and at least one participant who is non-collocated with the at least two participants in the first physical environment (e.g., the at least one participant is located in a second physical environment, different from the first physical environment). In some examples, a hybrid spatial group in the multi-user communication session has a spatial arrangement that dictates locations of users and content that are located in the spatial group. In some examples, users in the same hybrid spatial group within the multi-user communication session experience spatial truth according to the spatial arrangement of the spatial group, as similarly discussed above.

In some examples, initiating a multi-user communication session may include interaction with one or more user interface elements. In some examples, a user's gaze may be tracked by an electronic device as an input for targeting a selectable option/affordance within a respective user interface element that is displayed in the three-dimensional environment. For example, gaze can be used to identify one or more options/affordances targeted for selection using another selection input. In some examples, a respective option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

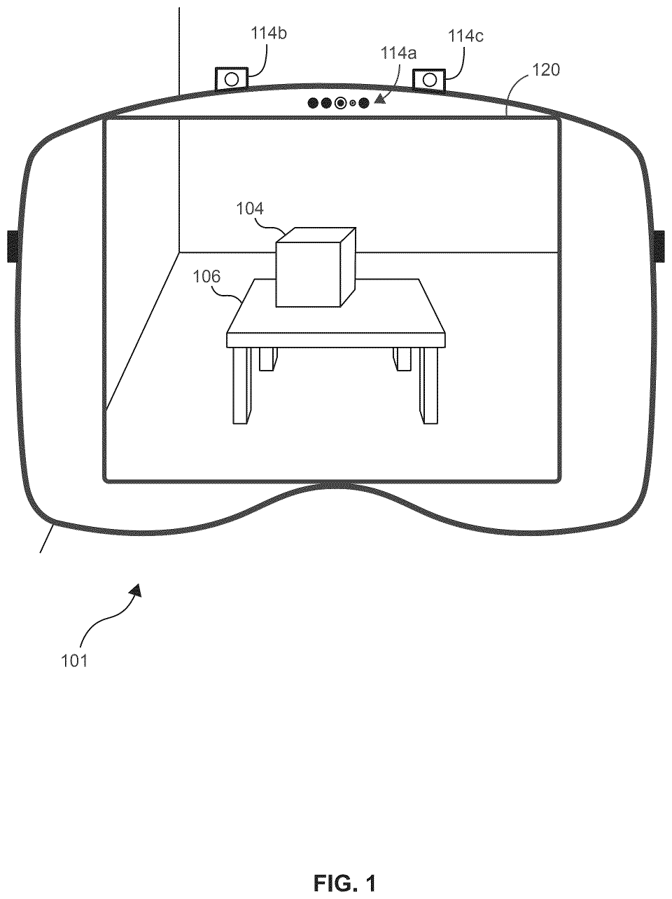

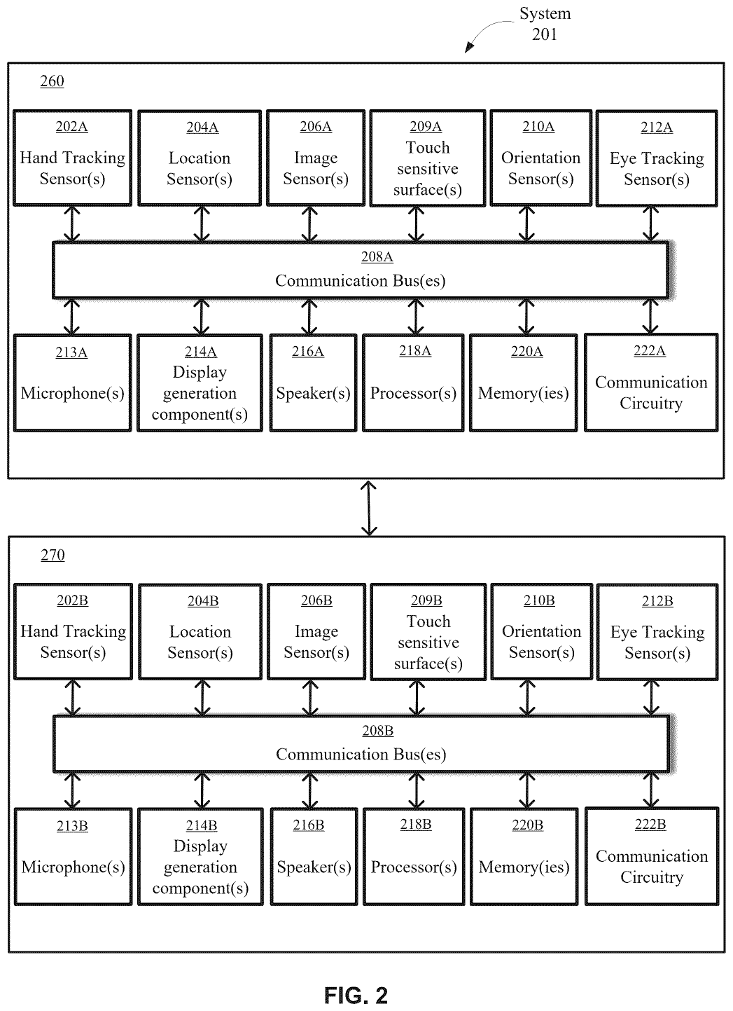

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head- mountable device configured to be worn on a head of a user of the electronic device 101. Examples of electronic device 101 are described below with reference to the architecture block diagram of FIG. 2. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIG. 2). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device may be a video-passthrough device in which display 120 is an opaque display configured to display images of the physical environment captured by external image sensors 114b and 114c. While a single display 120 is shown, it should be appreciated that display 120 may include a stereo pair of displays.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an example architecture for a system 201 according to some examples of the disclosure. In some examples, system 201 includes multiple devices. For example, the system 201 includes a first electronic device 260 and a second electronic device 270, wherein the first electronic device 260 and the second electronic device 270 are in communication with each other. In some examples, the first electronic device 260 and the second electronic device 270 are a portable device, such as a mobile phone, smart phone, a tablet computer, a laptop computer, an auxiliary device in communication with another device, a head-mounted display, etc., respectively. In some examples, the first electronic device 260 and the second electronic device 270 correspond to electronic device 101 described above with reference to FIG. 1.

As illustrated in FIG. 2, the first device 260 optionally includes various sensors (e.g., one or more hand tracking sensors 202A, one or more location sensors 204A, one or more image sensors 206A, one or more touch-sensitive surfaces 209A, one or more motion and/or orientation sensors 210A, one or more eye tracking sensors 212A, one or more microphones 213A or other audio sensors, one or more body tracking sensors (e.g., torso and/or head tracking sensors), one or more display generation components 214A, one or more speakers 216A, one or more processors 218A, one or more memories 220A, and/or communication circuitry 222A. In some examples, the second device 270 optionally includes various sensors (e.g., one or more hand tracking sensors 202B, one or more location sensors 204B, one or more image sensors 206B, one or more touch-sensitive surfaces 209B, one or more motion and/or orientation sensors 210B, one or more eye tracking sensors 212B, one or more microphones 213B or other audio sensors, one or more body tracking sensors (e.g., torso and/or head tracking sensors), one or more display generation components 214B, one or more speakers 216, one or more processors 218B, one or more memories 220B, and/or communication circuitry 222B. In some examples, the one or more display generation components 214A, 214B correspond to display 120 in FIG. 1. One or more communication buses 208A and 208B are optionally used for communication between the above-mentioned components of electronic devices 260 and 270, respectively. First electronic device 260 and second electronic device 270 optionally communicate via a wired or wireless connection (e.g., via communication circuitry 222A, 222B) between the two devices.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®.

Processor(s) 218A, 218B include one or more general processors, one or more graphics processors, and/or one or more digital signal processors. In some examples, memory 220A, 220B is a non-transitory computer-readable storage medium (e.g., flash memory, random access memory, or other volatile or non-volatile memory or storage) that stores computer-readable instructions configured to be executed by processor(s) 218A, 218B to perform the techniques, processes, and/or methods described below. In some examples, memory 220A, 220B can include more than one non-transitory computer-readable storage medium. A non- transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non- transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214A, 214B include a single display (e.g., a liquid-crystal display (LCD), organic light-emitting diode (OLED), or other types of display). In some examples, display generation component(s) 214A, 214B includes multiple displays. In some examples, display generation component(s) 214A, 214B can include a display with touch capability (e.g., a touch screen), a projector, a holographic projector, a retinal projector, a transparent or translucent display, etc. In some examples, electronic devices 260 and 270 include touch-sensitive surface(s) 209A and 209B, respectively, for receiving user inputs, such as tap inputs and swipe inputs or other gestures. In some examples, display generation component(s) 214A, 214B and touch-sensitive surface(s) 209A, 209B form touch-sensitive display(s) (e.g., a touch screen integrated with electronic devices 260 and 270, respectively, or external to electronic devices 260 and 270, respectively, that is in communication with electronic devices 260 and 270).

Electronic devices 260 and 270 optionally include image sensor(s) 206A and 206B, respectively. Image sensors(s) 206A/206B optionally include one or more visible light image sensors, such as charged coupled device (CCD) sensors, and/or complementary metal-oxide-semiconductor (CMOS) sensors operable to obtain images of physical objects from the real-world environment. Image sensor(s) 206A/206B also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206A/206B also optionally include one or more cameras configured to capture movement of physical objects in the real-world environment. Image sensor(s) 206A/206B also optionally include one or more depth sensors configured to detect the distance of physical objects from electronic device 260/270. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic devices 260 and 270 use CCD sensors, event cameras, and depth sensors in combination to detect the physical environment around electronic devices 260 and 270. In some examples, image sensor(s) 206A/206B include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 260/270 uses image sensor(s) 206A/206B to detect the position and orientation of electronic device 260/270 and/or display generation component(s) 214A/214B in the real-world environment. For example, electronic device 260/270 uses image sensor(s) 206A/206B to track the position and orientation of display generation component(s) 214A/214B relative to one or more fixed objects in the real-world environment.

In some examples, electronic device 260/270 includes microphone(s) 213A/213B or other audio sensors. Device 260/270 uses microphone(s) 213A/213B to detect sound from the user and/or the real-world environment of the user. In some examples, microphone(s) 213A/213B includes an array of microphones (a plurality of microphones) that optionally operate in tandem, such as to identify ambient noise or to locate the source of sound in space of the real-world environment.

In some examples, device 260/270 includes location sensor(s) 204A/204B for detecting a location of device 260/270 and/or display generation component(s) 214A/214B. For example, location sensor(s) 204A/204B can include a global positioning system (GPS) receiver that receives data from one or more satellites and allows electronic device 260/270 to determine the device's absolute position in the physical world.

In some examples, electronic device 260/270 includes orientation sensor(s) 210A/210B for detecting orientation and/or movement of electronic device 260/270 and/or display generation component(s) 214A/214B. For example, electronic device 260/270 uses orientation sensor(s) 210A/210B to track changes in the position and/or orientation of electronic device 260/270 and/or display generation component(s) 214A/214B, such as with respect to physical objects in the real-world environment. Orientation sensor(s) 210A/210B optionally include one or more gyroscopes and/or one or more accelerometers.

Electronic device 260/270 includes hand tracking sensor(s) 202A/202B and/or eye tracking sensor(s) 212A/212B (and/or other body tracking sensor(s), such as leg, torso, and/or head tracking sensor(s)), in some examples. Hand tracking sensor(s) 202A/202B are configured to track the position/location of one or more portions of the user's hands, and/or motions of one or more portions of the user's hands with respect to the extended reality environment, relative to the display generation component(s) 214A/214B, and/or relative to another defined coordinate system. Eye tracking sensor(s) 212A/212B are configured to track the position and movement of a user's gaze (eyes, face, or head, more generally) with respect to the real-world or extended reality environment and/or relative to the display generation component(s) 214A/214B. In some examples, hand tracking sensor(s) 202A/202B and/or eye tracking sensor(s) 212A/212B are implemented together with the display generation component(s) 214A/214B. In some examples, the hand tracking sensor(s) 202A/202B and/or eye tracking sensor(s) 212A/212B are implemented separate from the display generation component(s) 214A/214B.

In some examples, the hand tracking sensor(s) 202A/202B (and/or other body tracking sensor(s), such as leg, torso, and/or head tracking sensor(s)) can use image sensor(s) 206A/206B (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, one or more image sensors 206A/206B are positioned relative to the user to define a field of view of the image sensor(s) 206A/206B and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212A/212B includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic device 260/270 and system 201 are not limited to the components and configuration of FIG. 2, but can include fewer, other, or additional components in multiple configurations. In some examples, system 201 can be implemented in a single device. A person or persons using system 201, is optionally referred to herein as a user or users of the device(s). Attention is now directed towards exemplary concurrent displays of a three-dimensional environment on a first electronic device (e.g., corresponding to electronic device 260) and a second electronic device (e.g., corresponding to electronic device 270). As discussed below, the first electronic device may be in communication with the second electronic device in a multi-user communication session. In some examples, an avatar (e.g., a representation of) a user of the first electronic device may be displayed in the three-dimensional environment at the second electronic device, and an avatar of a user of the second electronic device may be displayed in the three-dimensional environment at the first electronic device. In some examples, the user of the first electronic device and the user of the second electronic device may be associated with a spatial group in the multi-user communication session. In some examples, interactions with content in the three-dimensional environment while the first electronic device and the second electronic device are in the multi-user communication session may cause the user of the first electronic device and the user of the second electronic device to become associated with different spatial groups in the multi-user communication session.

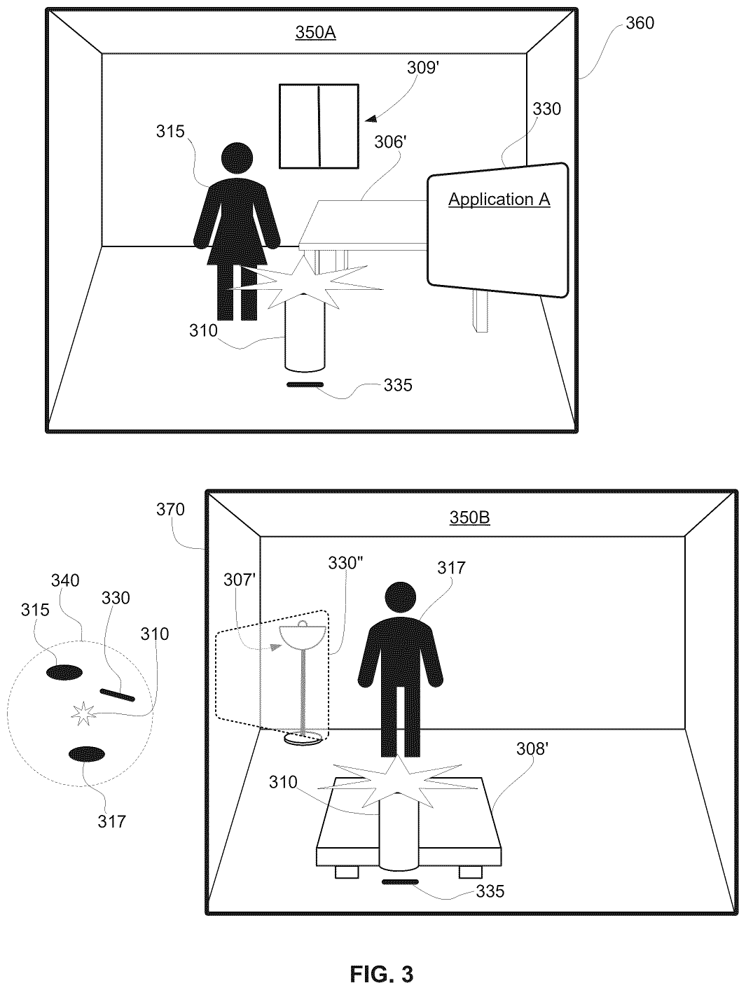

FIG. 3 illustrates an example of a spatial group 340 in a multi-user communication session that includes a first electronic device 360 and a second electronic device 370 according to some examples of the disclosure. In some examples, the first electronic device 360 may present a three-dimensional environment 350A, and the second electronic device 370 may present a three-dimensional environment 350B. The first electronic device 360 and the second electronic device 370 may be similar to electronic device 101 or 260/270, and/or may be a head mountable system/device and/or projection-based system/device (including a hologram-based system/device) configured to generate and present a three-dimensional environment, such as, for example, heads-up displays (HUDs), head mounted displays (HMDs), windows having integrated display capability, displays formed as lenses designed to be placed on a person's eyes (e.g., similar to contact lenses), respectively. In the example of FIG. 3, a first user is optionally wearing the first electronic device 360 and a second user is optionally wearing the second electronic device 370, such that the three-dimensional environment 350A/350B can be defined by X, Y and Z axes as viewed from a perspective of the electronic devices (e.g., a viewpoint associated with the electronic device 360/370, which may be a head-mounted display, for example).

As shown in FIG. 3, the first electronic device 360 may be in a first physical environment that includes a table 306 and a window 309. Thus, the three-dimensional environment 350A presented using the first electronic device 360 optionally includes captured portions of the physical environment surrounding the first electronic device 360, such as a representation of the table 306′ and a representation of the window 309′. Similarly, the second electronic device 370 may be in a second physical environment, different from the first physical environment (e.g., separate from the first physical environment), that includes a floor lamp 307 and a coffee table 308. Thus, the three-dimensional environment 350B presented using the second electronic device 370 optionally includes captured portions of the physical environment surrounding the second electronic device 370, such as a representation of the floor lamp 307′ and a representation of the coffee table 308′. Additionally, the three-dimensional environments 350A and 350B may include representations of the floor, ceiling, and walls of the room in which the first electronic device 360 and the second electronic device 370, respectively, are located.

As mentioned above, in some examples, the first electronic device 360 is optionally in a multi-user communication session with the second electronic device 370. For example, the first electronic device 360 and the second electronic device 370 (e.g., via communication circuitry 222A/222B) are configured to present a shared three-dimensional environment 350A/350B that includes one or more shared virtual objects (e.g., content such as images, video, audio and the like, representations of user interfaces of applications, etc.). As used herein, the term “shared three-dimensional environment” refers to a three-dimensional environment that is independently presented, displayed, and/or visible at two or more electronic devices via which content, applications, data, and the like may be shared and/or presented to users of the two or more electronic devices. In some examples, while the first electronic device 360 is in the multi-user communication session with the second electronic device 370, an avatar corresponding to the user of one electronic device is optionally displayed in the three- dimensional environment that is displayed via the other electronic device. For example, as shown in FIG. 3, at the first electronic device 360, an avatar 315 corresponding to the user of the second electronic device 370 is displayed in the three-dimensional environment 350A. Similarly, at the second electronic device 370, an avatar 317 corresponding to the user of the first electronic device 360 is displayed in the three-dimensional environment 350B.

In some examples, the presentation of avatars 315/317 as part of a shared three-dimensional environment is optionally accompanied by an audio effect corresponding to a voice of the users of the electronic devices 370/360. For example, the avatar 315 displayed in the three-dimensional environment 350A using the first electronic device 360 is optionally accompanied by an audio effect corresponding to the voice of the user of the second electronic device 370. In some such examples, when the user of the second electronic device 370 speaks, the voice of the user may be detected by the second electronic device 370 (e.g., via the microphone(s) 213B) and transmitted to the first electronic device 360 (e.g., via the communication circuitry 222B/222A), such that the detected voice of the user of the second electronic device 370 may be presented as audio (e.g., using speaker(s) 216A) to the user of the first electronic device 360 in three-dimensional environment 350A. In some examples, the audio effect corresponding to the voice of the user of the second electronic device 370 may be spatialized such that it appears to the user of the first electronic device 360 to emanate from the location of avatar 315 in the shared three-dimensional environment 350A (e.g., despite being outputted from the speakers of the first electronic device 360). Similarly, the avatar 317 displayed in the three-dimensional environment 350B using the second electronic device 370 is optionally accompanied by an audio effect corresponding to the voice of the user of the first electronic device 360. In some such examples, when the user of the first electronic device 360 speaks, the voice of the user may be detected by the first electronic device 360 (e.g., via the microphone(s) 213A) and transmitted to the second electronic device 370 (e.g., via the communication circuitry 222A/222B), such that the detected voice of the user of the first electronic device 360 may be presented as audio (e.g., using speaker(s) 216B) to the user of the second electronic device 370 in three-dimensional environment 350B. In some examples, the audio effect corresponding to the voice of the user of the first electronic device 360 may be spatialized such that it appears to the user of the second electronic device 370 to emanate from the location of avatar 317 in the shared three-dimensional environment 350B (e.g., despite being outputted from the speakers of the first electronic device 360).

In some examples, while in the multi-user communication session, the avatars 315/317 are displayed in the three-dimensional environments 350A/350B with respective orientations that correspond to and/or are based on orientations of the electronic devices 360/370 (and/or the users of electronic devices 360/370) in the physical environments surrounding the electronic devices 360/370. For example, as shown in FIG. 3, in the three-dimensional environment 350A, the avatar 315 is optionally facing toward the viewpoint of the user of the first electronic device 360, and in the three-dimensional environment 350B, the avatar 317 is optionally facing toward the viewpoint of the user of the second electronic device 370. As a particular user moves the electronic device (and/or themself) in the physical environment, the viewpoint of the user changes in accordance with the movement, which may thus also change an orientation of the user's avatar in the three-dimensional environment. For example, with reference to FIG. 3, if the user of the first electronic device 360 were to look leftward in the three-dimensional environment 350A such that the first electronic device 360 is rotated (e.g., a corresponding amount) to the left (e.g., counterclockwise), the user of the second electronic device 370 would see the avatar 317 corresponding to the user of the first electronic device 360 rotate to the right (e.g., clockwise) relative to the viewpoint of the user of the second electronic device 370 in accordance with the movement of the first electronic device 360.

Additionally, in some examples, while in the multi-user communication session, a viewpoint of the three-dimensional environments 350A/350B and/or a location of the viewpoint of the three-dimensional environments 350A/350B optionally changes in accordance with movement of the electronic devices 360/370 (e.g., by the users of the electronic devices 360/370). For example, while in the communication session, if the first electronic device 360 is moved closer toward the representation of the table 306′ and/or the avatar 315 (e.g., because the user of the first electronic device 360 moved forward in the physical environment surrounding the first electronic device 360), the viewpoint of the three-dimensional environment 350A would change accordingly, such that the representation of the table 306′, the representation of the window 309′ and the avatar 315 appear larger in the field of view. In some examples, each user may independently interact with the three-dimensional environment 350A/350B, such that changes in viewpoints of the three-dimensional environment 350A and/or interactions with virtual objects in the three-dimensional environment 350A by the first electronic device 360 optionally do not affect what is shown in the three-dimensional environment 350B at the second electronic device 370, and vice versa.

In some examples, the avatars 315/317 are representations (e.g., a full-body rendering) of the users of the electronic devices 370/360. In some examples, the avatar 315/317 is a representation of a portion (e.g., a rendering of a head, face, head and torso, etc.) of the users of the electronic devices 370/360. In some examples, the avatars 315/317 are user-personalized, user-selected, and/or user-created representations displayed in the three-dimensional environments 350A/350B that are representative of the users of the electronic devices 370/360. It should be understood that, while the avatars 315/317 illustrated in FIG. 3 correspond to full-body representations of the users of the electronic devices 370/360, respectively, alternative avatars may be provided, such as those described above.

As mentioned above, while the first electronic device 360 and the second electronic device 370 are in the multi-user communication session, the three-dimensional environments 350A/350B may be a shared three-dimensional environment that is presented using the electronic devices 360/370. In some examples, content that is viewed by one user at one electronic device may be shared with another user at another electronic device in the multi-user communication session. In some such examples, the content may be experienced (e.g., viewed and/or interacted with) by both users (e.g., via their respective electronic devices) in the shared three-dimensional environment. For example, as shown in FIG. 3, the three-dimensional environments 350A/350B include a shared virtual object 310 (e.g., which is optionally a three-dimensional virtual sculpture) that is viewable by and interactive to both users. As shown in FIG. 3, the shared virtual object 310 may be displayed with a grabber affordance (e.g., a handlebar) 335 that is selectable to initiate movement of the shared virtual object 310 within the three-dimensional environments 350A/350B.

In some examples, the three-dimensional environments 350A/350B include unshared content that is private to one user in the multi-user communication session. For example, in FIG. 3, the first electronic device 360 is displaying a private application window 330 in the three-dimensional environment 350A, which is optionally an object that is not shared between the first electronic device 360 and the second electronic device 370 in the multi-user communication session. In some examples, the private application window 330 may be associated with a respective application that is operating on the first electronic device 360 (e.g., such as a media player application, a web browsing application, a messaging application, etc.). Because the private application window 330 is not shared with the second electronic device 370, the second electronic device 370 optionally displays a representation of the private application window 330″ in three-dimensional environment 350B. As shown in FIG. 3, in some examples, the representation of the private application window 330″ may be a faded, occluded, discolored, and/or translucent representation of the private application window 330 that prevents the user of the second electronic device 370 from viewing contents of the private application window 330.

As mentioned previously above, in some examples, the user of the first electronic device 360 and the user of the second electronic device 370 are in a spatial group 340 within the multi-user communication session. In some examples, the spatial group 340 may be a baseline (e.g., a first or default) spatial group within the multi-user communication session. For example, when the user of the first electronic device 360 and the user of the second electronic device 370 initially join the multi-user communication session, the user of the first electronic device 360 and the user of the second electronic device 370 are automatically (and initially, as discussed in more detail below) associated with (e.g., grouped into) the spatial group 340 within the multi-user communication session. In some examples, while the users are in the spatial group 340 as shown in FIG. 3, the user of the first electronic device 360 and the user of the second electronic device 370 have a first spatial arrangement (e.g., first spatial template) within the shared three-dimensional environment. For example, the user of the first electronic device 360 and the user of the second electronic device 370, including objects that are displayed in the shared three-dimensional environment, have spatial truth within the spatial group 340. In some examples, spatial truth requires a consistent spatial arrangement between users (or representations thereof) and virtual objects. For example, a distance between the viewpoint of the user of the first electronic device 360 and the avatar 315 corresponding to the user of the second electronic device 370 may be the same as a distance between the viewpoint of the user of the second electronic device 370 and the avatar 317 corresponding to the user of the first electronic device 360. As described herein, if the location of the viewpoint of the user of the first electronic device 360 moves, the avatar 317 corresponding to the user of the first electronic device 360 moves in the three-dimensional environment 350B in accordance with the movement of the location of the viewpoint of the user relative to the viewpoint of the user of the second electronic device 370. Additionally, if the user of the first electronic device 360 performs an interaction on the shared virtual object 310 (e.g., moves the virtual object 310 in the three-dimensional environment 350A), the second electronic device 370 alters display of the shared virtual object 310 in the three-dimensional environment 350B in accordance with the interaction (e.g., moves the virtual object 310 in the three-dimensional environment 350B).

It should be understood that, in some examples, more than two electronic devices may be communicatively linked in a multi-user communication session. For example, in a situation in which three electronic devices are communicatively linked in a multi-user communication session, a first electronic device would display two avatars, rather than just one avatar, corresponding to the users of the other two electronic devices. It should therefore be understood that the various processes and exemplary interactions described herein with reference to the first electronic device 360 and the second electronic device 370 in the multi-user communication session optionally apply to situations in which more than two electronic devices are communicatively linked in a multi-user communication session.

In some examples, it may be advantageous to provide mechanisms for facilitating a multi-user communication session that includes collocated and non-collocated users (e.g., collocated and non-collocated electronic devices associated with the users). For example, it may be desirable to enable users who are collocated in a first physical environment to establish a multi-user communication session with one or more users who are non-collocated in the first physical environment, such that virtual content may be shared and presented in a three- dimensional environment that is optionally viewable by and/or interactive to the collocated and non-collocated users in the multi-user communication session. As used herein, relative to a first electronic device, a collocated user corresponds to a local user and a non-collocated user corresponds to a remote user. As similarly discussed above, the three-dimensional environment optionally includes avatars corresponding to the remote users of the electronic devices that are non-collocated in the multi-user communication session. In some examples, as discussed below, the presentation of virtual objects (e.g., avatars and shared virtual content) in the three-dimensional environment within a multi-user communication session that includes collocated and non-collocated users (e.g., relative to a first electronic device) is based on positions and/or orientations of the collocated users in a physical environment of the first electronic device.

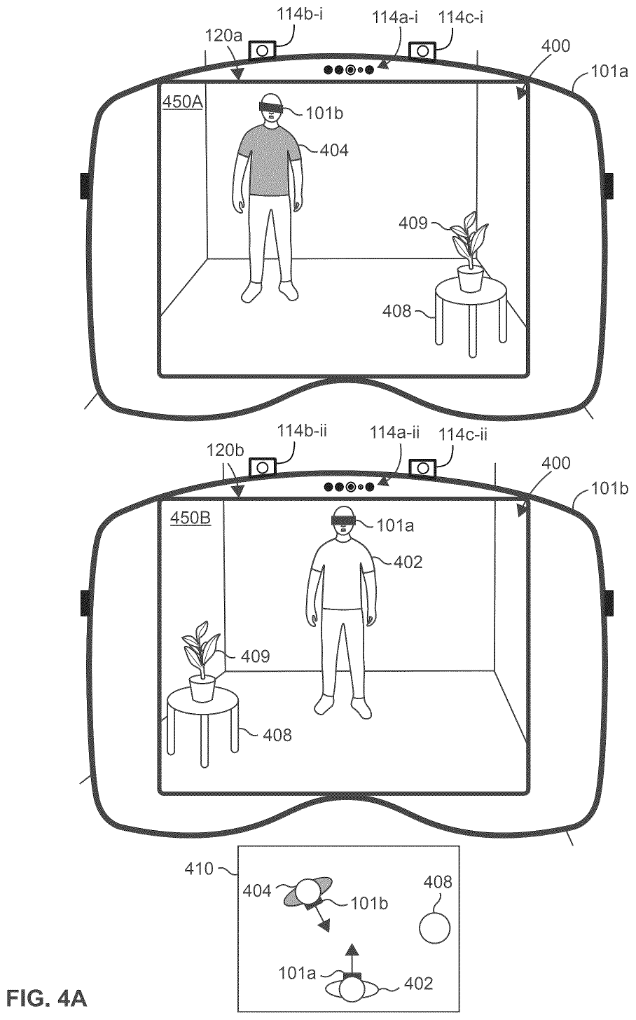

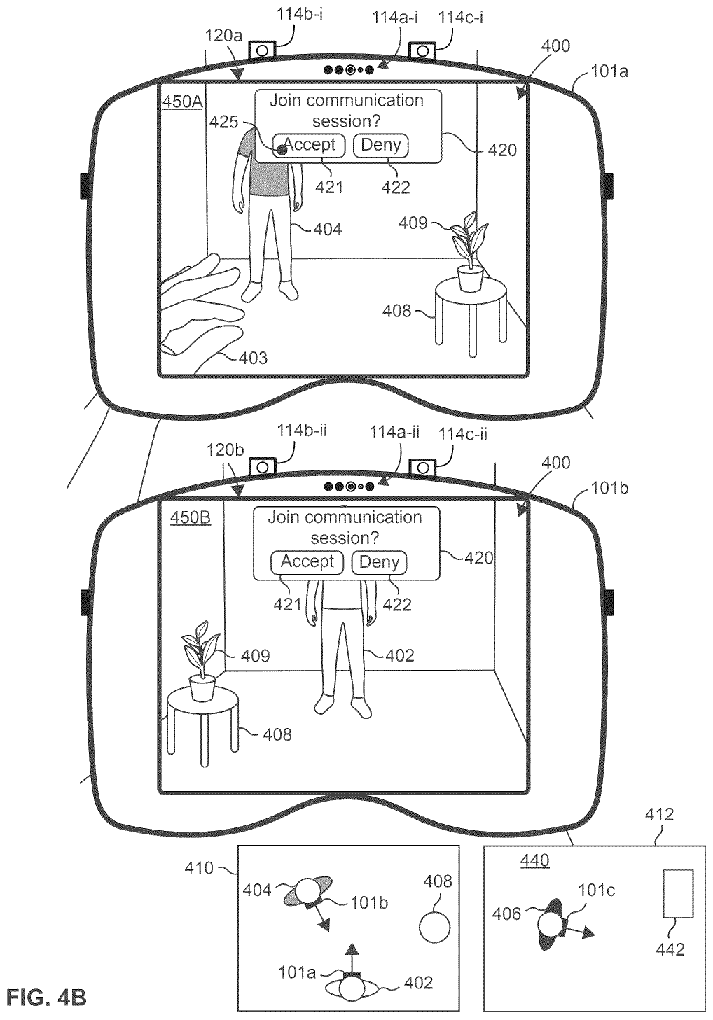

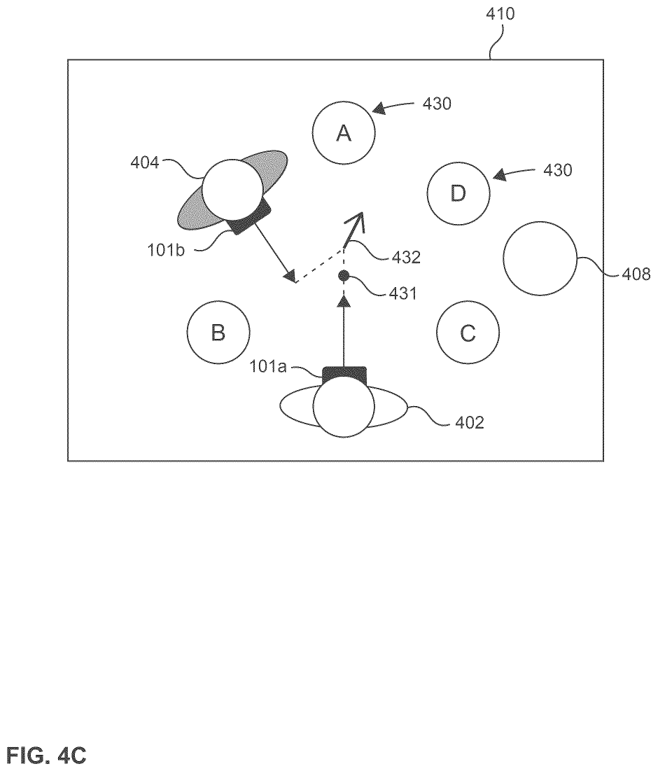

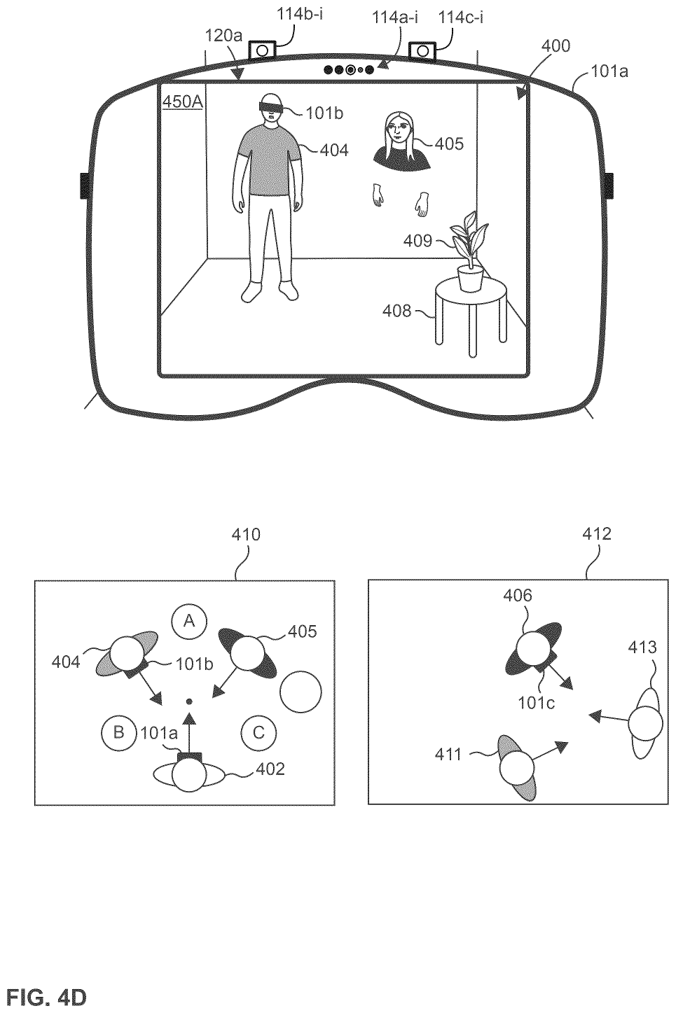

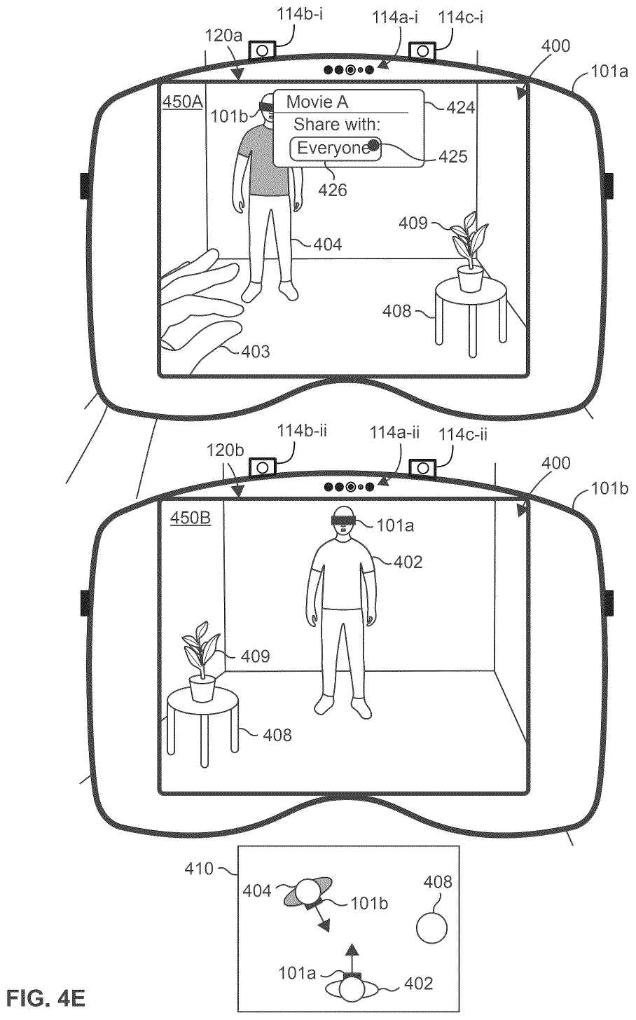

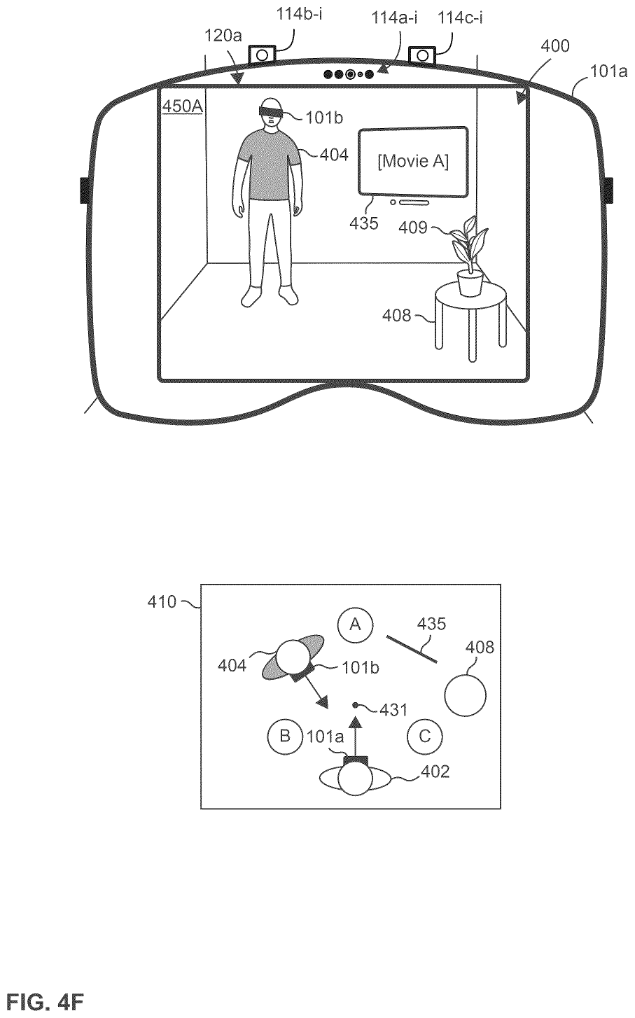

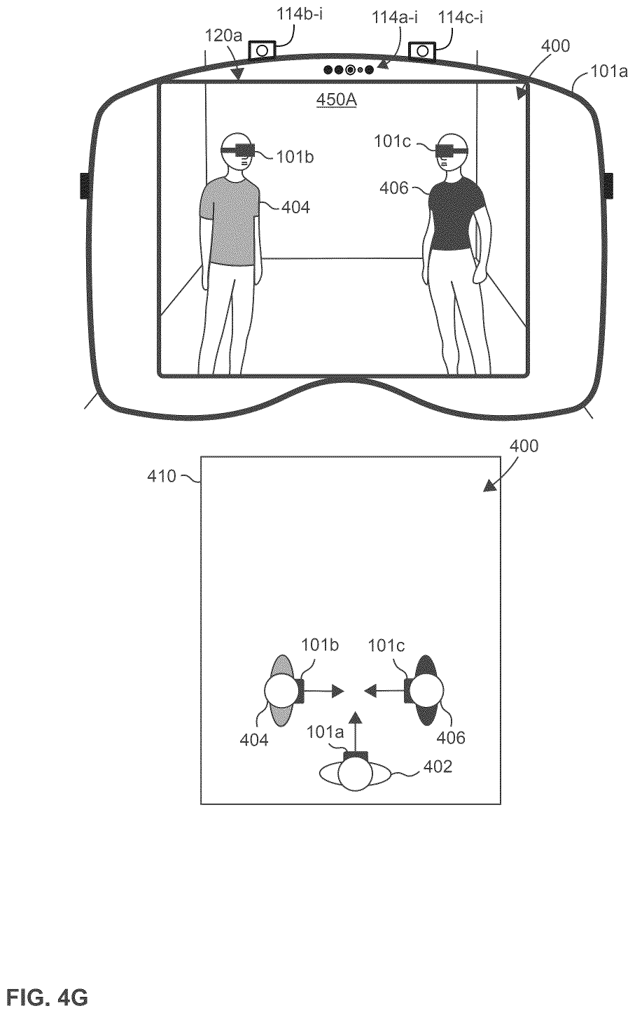

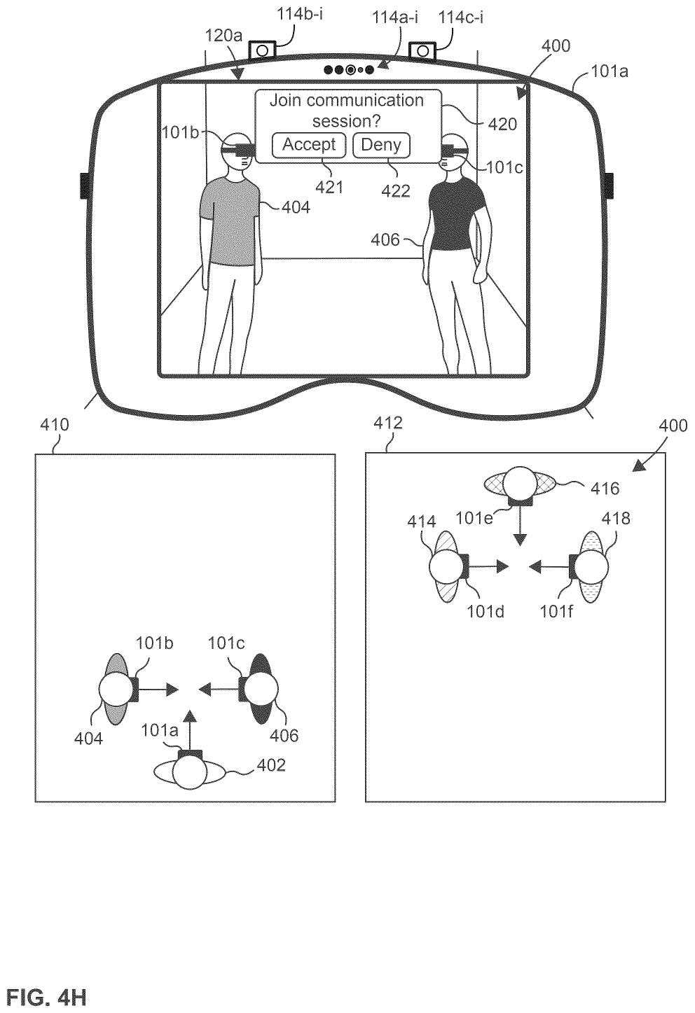

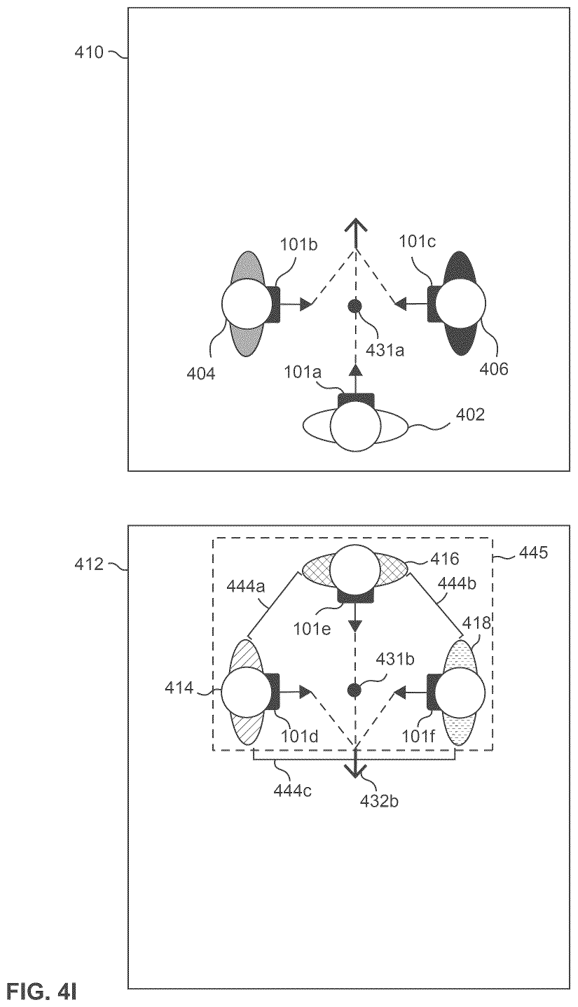

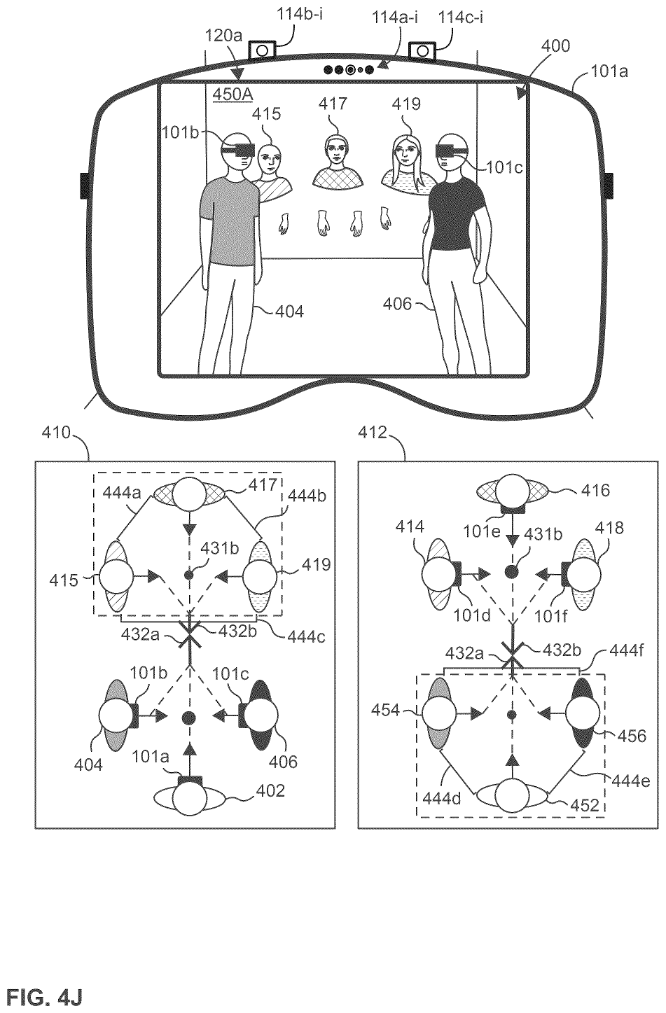

FIGS. 4A-4J illustrate examples of initiating a multi-user communication session that includes collocated and non-collocated users according to some examples of the disclosure. In some examples, while a first electronic device 101a is in the multi-user communication session with a second electronic device 101b, three-dimensional environment 450A is presented using the first electronic device 101a (e.g., via display 120a) and three-dimensional environment 450B is presented using the second electronic device 101b (e.g., via display 120b). In some examples, the electronic devices 101a/101b optionally correspond to or are similar to electronic devices 360/370 discussed above and/or electronic devices 260/270 in FIG. 2. In some examples, as shown in FIG. 4A, the first electronic device 101a is being used by (e.g., worn on a head of) a first user 402 and the second electronic device 101b is being used by (e.g., worn on a head of) a second user 404.

In FIG. 4A, as indicated in overhead view 410, the first electronic device 101a and the second electronic device 101b are collocated in physical environment 400. For example, the first electronic device 101a and the second electronic device 101b are both located in a same room that includes stand 408 and houseplant 409. In some examples, the determination that the first electronic device 101a and the second electronic device 101b are collocated in the physical environment 400 is based on a distance between the first electronic device 101a and the second electronic device 101b. For example, in FIG. 4A, the first electronic device 101a and the second electronic device 101b are collocated in the physical environment 400 because the first electronic device 101a is within a threshold distance (e.g., 0.1, 0.5, 1, 2, 3, 5, 10, 15, 20, etc. meters) of the second electronic device 101b. In some examples, the determination that the first electronic device 101a and the second electronic device 101b are collocated in the physical environment 400 is based on communication between the first electronic device 101a and the second electronic device 101b. For example, in FIG. 4A, the first electronic device 101a and the second electronic device 101b are configured to communicate (e.g., wirelessly, such as via Bluetooth, Wi-Fi, or a server (e.g., wireless communications terminal)). In some examples, the first electronic device 101a and the second electronic device 101b are connected to a same wireless network in the physical environment 400. In some examples, the determination that the first electronic device 101a and the second electronic device 101b are collocated in the physical environment 400 is based on a strength of a wireless signal transmitted between the electronic device 101a and 101b. For example, in FIG. 4A, the first electronic device 101a and the second electronic device 101b are collocated in the physical environment 400 because a strength of a Bluetooth signal (or other wireless signal) transmitted between the electronic devices 101a and 101b is greater than a threshold strength. In some examples, the determination that the first electronic device 101a and the second electronic device 101b are collocated in the physical environment 400 is based on visual detection of the electronic devices 101a and 101b in the physical environment 400. For example, as shown in FIG. 4A, the second electronic device 101b is positioned in a field of view of the first electronic device 101a (e.g., because the second user 404 is standing in the field of view of the first electronic device 101a), which enables the first electronic device 101a to visually detect (e.g., identify or scan, such as via object detection or other image processing techniques) the second electronic device 101b (e.g., in one or more images captured by the first electronic device 101a, such as via external image sensors 114b-i and 114c-i). Similarly, as shown in FIG. 4A, the first electronic device 101a is optionally positioned in a field of view of the second electronic device 101b (e.g., because the first user 402 is standing in the field of view of the second electronic device 101b), which enables the second electronic device 101b to visually detect the first electronic device 101a (e.g., in one or more images captured by the second electronic device 101b, such as via external image sensors 11b-ii and 114c-ii).

In some examples, the three-dimensional environments 450A/450B include captured portions of the physical environment 400 in which the electronic devices 460/470 are located. For example, because the first electronic device 101a and the second electronic device 101b are collocated in the physical environment 400, the three-dimensional environments 450A and 450B include the stand 408 (e.g., a representation of the stand) and the houseplant 409 (e.g., a representation of the houseplant), but from the viewpoints of the first electronic device 101a and the second electronic device 101b, as shown in FIG. 4A. In some examples, the representations can include portions of the physical environment 400 viewed through a transparent or translucent display of the electronic devices 101a and 101b. In some examples, the three-dimensional environments 450A/450B have one or more characteristics of the three-dimensional environments 350A/350B described above with reference to FIG. 3.

As described above with reference to FIG. 3, while electronic devices are communicatively linked in a multi-user communication session, users may be represented by avatars corresponding to the users of the electronic devices. In FIG. 4A, because the first electronic device 101a and the second electronic device 101b are collocated in the physical environment 400, the users of the electronic devices 101a and 101b are represented in the multi-user communication session via their physical personas (e.g., bodies) that are visible in passthrough of the physical environment 400 (e.g., rather than via virtual avatars). For example, as shown in FIG. 4A, the second user 404 is visible in the field of view of the first electronic device 101a and the first user 402 is visible in the field of view of the second electronic device 101b while the first electronic device 101a and the second electronic device 101b are in the multi-user communication session. As discussed in more detail below, if a third user who is non-collocated in the physical environment 400 (e.g., a remote user) joins the multi-user communication session, the third user is represented via an avatar in the three-dimensional environments 450A and 450B.

As similarly described above with reference to FIG. 3, while the first user 402 of the first electronic device 101a and the second user 404 of the second electronic device 101b are collocated in the physical environment 400 and while the first electronic device 101a is in the multi-user communication session with the second electronic device 101b, the first user 402 and the second user 404 may be in a first spatial group within the multi-user communication session In some examples, the first spatial group has one or more characteristics of spatial group 340 discussed above with reference to FIG. 3. As similarly described above, while the first user 402 and the second user 404 are in the first spatial group within the multi-user communication session, the users have a first spatial arrangement in the shared three-dimensional environment (e.g., represented by the locations of and/or distance between the users 402 and 404 in the overhead view 410 in FIG. 4A) determined by the physical locations of the electronic devices 101a and 101b in the physical environment 440. Particularly, the first electronic device 101a and the second electronic device 101b experience spatial truth within the first spatial group as dictated by the physical locations of and/or orientations of the first user 402 and the second user 404, respectively.

In FIG. 4B, while the first electronic device 101a is collocated with the second electronic device 101b in the physical environment 400 (e.g., and optionally while the first electronic device 101a is in a multi-user communication session with the second electronic device 110b), the first electronic device 101a and the second electronic device 101b detect an indication of a request to join a multi-user communication session with a third electronic device. In some examples, the indication corresponds to an indication of a request to add the third electronic device to the current multi-user communication session between the first electronic device 101a and the second electronic device 101b.

In some examples, the third electronic device is non-collocated with the first electronic device 101a and the second electronic device 101b. For example, as shown in overhead view 412 in FIG. 4B, third electronic device 101c is located (e.g., with third user 406) in physical environment 440 (e.g., including table 442), which is different from the physical environment 400 in which the first electronic device 101a and the second electronic device 101b are both located. In some examples, while the third electronic device 101c is in the physical environment 440, the third electronic device 101c is more than the threshold distance (e.g., discussed above) of the first electronic device 101a and the second electronic device 101b. Additionally, in some examples, as shown in FIG. 4B, the third electronic device 101c is not in the field of view of the first electronic device 101a or the second electronic device 101b.

In some examples, when the first electronic device 101a and the second electronic device 101b detect the indication discussed above, the first electronic device 101a and the second electronic device 101b display message element 420 (e.g., a notification) corresponding to the request to join the multi-user communication session with the third electronic device 101c. In some examples, as shown in FIG. 4B, the message element 420 includes a first option 421 that is selectable to accept the request (e.g., and join the multi-user communication session with the third electronic device 101c) and a second option 422 that is selectable to deny the request (e.g., and forgo joining the multi-user communication session with the third electronic device 101c).

In FIG. 4B, the first electronic device 101a and the second electronic device 101b detect one or more inputs accepting the request to join the multi-user communication session with the third electronic device 101c. For example, in FIG. 4B, the first electronic device 101a and the second electronic device 101b detect a selection of the first option 421 in the message element 420. As an example, the first electronic device 101a and the second electronic device 101b detect an air pinch gesture directed to the first option 421. For example, as shown in FIG. 4B with respect to the first electronic device 101a, the first electronic device 101a and the second electronic device 101b detect a pinch performed by a hand of the first user 402 (e.g., hand 403) and a hand of the second user 404, respectively, optionally while a gaze of the first user 402 (e.g., gaze point 425) and a gaze of the second user 404 are directed to the first option 421 at the first electronic device 101a and the second electronic device 101b, respectively. It should be understood that additional or alternative inputs are possible, such as air tap gestures, gaze and dwell inputs, verbal commands, etc.

In some examples, in response to detecting the input accepting the request to join the multi-user communication session with the third electronic device 101c, the first electronic device 101a and the second electronic device 101b initiate a process for presenting an avatar corresponding to the third user 406 of the third electronic device 101c in the three-dimensional environments 450A and 450B, indicative of entering the multi-user communication session with the third electronic device 101c. For example, as mentioned above, because the third user 406 is non-collocated with the first user 402 and the second user 404 in the physical environment 400, the third user 406 is represented via an avatar (or other virtual representation) in the three-dimensional environment 450A/450B while in the multi-user communication session. In some examples, as discussed below, initiating the process for presenting the avatar corresponding to the third user 406 in the three-dimensional environment 450A/450B includes identifying a placement location for the avatar within the first spatial group of the first user 402 and the second user 404.

In some examples, as shown in FIG. 4C, when the first electronic device 101a and the second electronic device 101b identify a placement location for the avatar corresponding to the third user 406 in the first spatial group, as shown in the overhead view 410, the first electronic device 101a and the second electronic device 101b analyze/identify physical locations of the first electronic device 101a and the second electronic device 101b within a shared (e.g., synchronized) coordinate space/system of the first spatial group. For example, as indicated in the overhead view 410 in FIG. 4C, the first electronic device 101a is located at a first location relative to an origin 431 (e.g., a geometric center) of the first spatial group and the second electronic device 101b is located at a second location, different from the first location, relative to the origin 431. Furthermore, the first electronic device 101a is located a first distance from the origin 431 and the second electronic device 101b is located a second distance (e.g., different from or equal to the first distance) from the origin 431. Additionally, in some examples, the origin 431 enables virtual content (e.g., shared applications, user interfaces, three-dimensional objects/models, etc.) that is presented in the shared three-dimensional environment to be positioned at a same location within the first spatial group for all local users (e.g., by positioning the virtual content relative to the origin 431).

In some examples, the origin 431 (e.g., and thus the shared coordinate system) discussed above is defined based on the physical environment 400 (e.g., the physical room in which the first electronic device 101a and the second electronic device 101b are located). In some examples, the first electronic device 101a and the second electronic device 101b are each configured to analyze the physical environment 400 to determine the origin 431 (e.g., and the shared coordinate system) based on Simultaneous Localization and Mapping (SLAM) data exchanged between the first electronic device 101a and the second electronic device 101b (e.g., SLAM data individually stored on the electronic devices 101a and 101b or SLAM data stored on one of the electronic devices 101a and 101b). For example, the first electronic device 101a and the second electronic device 101b utilize the SLAM data to facilitate shared understanding of one or more physical properties of the physical environment 400, such as dimensions of the physical environment, physical objects within the physical environment, a visual appearance (e.g., color and lighting characteristics) of the physical environment, etc., according to which the origin 431 may be defined in the first spatial group. In some examples, the first electronic device 101a and the second electronic device 101b are each configured to analyze the physical environment 400 to determine the origin 431 based on one or more characteristics of the other electronic device as perceived by the electronic devices individually. For example, based on one or more images captured via the external image sensors 114b-i and 114c-i, the first electronic device 101a analyzes a position of the second electronic device 101b in the physical environment relative to the viewpoint of the first electronic device 101a and, based on one or more images captured via the external image sensors 114b-ii and 114c-ii, the second electronic device 101b analyzes a position of the first electronic device 101a in the physical environment 400 relative to the viewpoint of the second electronic device 101b to establish spatial truth within the first spatial group and thus define the origin 431.

In some examples, when the first electronic device 101a and the second electronic device 101b identify a placement location for the avatar corresponding to the third user 406 in the first spatial group, as shown in the overhead view 410, the first electronic device 101a and the second electronic device 101b analyze/identify one or more physical properties of the physical environment 400. For example, as discussed above, the physical environment 400 includes stand 408 (e.g., including houseplant 409). In some examples, the first electronic device 101a and the second electronic device 101b select a placement location for the avatar corresponding to the user of the third electronic device based on a location of the stand 408 in the physical environment 400. For example, the location at which the avatar corresponding to the third user is positioned in the shared three-dimensional environment is selected to not correspond to the location of the stand 408 in the physical environment 400.

In some examples, as shown in FIG. 4C, when the first electronic device 101a and the second electronic device 101b identify a placement location for the avatar corresponding to the third user 406 in the first spatial group, as shown in the overhead view 410, the first electronic device 101a and the second electronic device 101b analyze/identify orientations of the first electronic device 101a and the second electronic device 101b within the first spatial group. For example, the orientation of the first electronic device 101a defines a forward direction of the first electronic device 101a (e.g., a forward head direction of the first user 402) and the orientation of the second electronic device 101b defines a forward direction of the second electronic device 101b (e.g., a forward head direction of the second user 404). In FIG. 4C, as an example, the forward direction of the first electronic device 101a and the forward direction of the second electronic device 101b are indicated by the arrows extending from the first electronic device 101a and the second electronic device 101b, respectively, in the overhead view 410. In some examples, the first electronic device 101a and the second electronic device 101b utilize the forward directions of the electronic devices 101a and 101b to determine an average forward direction of the electronic devices 101a and 101b in the first spatial group (e.g., an average forward head direction of the users 402 and 404). For example, as indicated in the overhead view 410, the first electronic device 101a and the second electronic device 101b determine average forward direction 432 in the first spatial group based on averaging the forward directions of the first electronic device 101a and the second electronic device 101b.

In some examples, the when the first electronic device 101a and the second electronic device 101b identify a placement location for the avatar corresponding to the third user 406 in the first spatial group, as shown in the overhead view 410, the first electronic device 101a and the second electronic device 101b analyze/identify one or more properties of the shared three-dimensional environment. In some examples, the one or more properties of the shared three-dimensional environment correspond to the presence of virtual objects (e.g., shared content) currently displayed in the shared three-dimensional environment (e.g., none of which exist in the current example of FIG. 4C). In some examples, the one or more properties of the shared three-dimensional environment include a spatial template associated with the first spatial group. For example, as indicated in the overhead view 410 in FIG. 4C, the spatial template indicates a plurality or number of seats which participants in the multi-user communication session can occupy. As used herein, a spatial group within the multi-user communication session may be associated with a plurality of seats that determines the spatial arrangement of the spatial group. For example, the spatial group is configured to accommodate a plurality of users (e.g., from two users up to “n” users) and each user of the plurality of users is assigned to (e.g., occupies) a seat of the plurality of seats within the spatial group. In the example of FIG. 4C, the first user 402 is occupying a first seat and the second user 404 is occupying a second seat of the plurality of seats 430 in the first spatial group. Accordingly, if the first spatial group is associated with a spatial template, as indicated in the overhead view 410, unoccupied seats (e.g., labeled A, B, C, and D) of the plurality of seats 430 correspond to locations within the first spatial group at which the avatar corresponding to the third user may be placed.

In some examples, the first electronic device 101a and the second electronic device 101b select/coordinate a placement location for the avatar corresponding to the third user based on any one or combination of the factors described above. In FIG. 4D, after selecting the placement location for the avatar corresponding to the third user, the first electronic device 101a and the second electronic device 101b present the avatar 405 corresponding to the third user 406 of the third electronic device 101c. In some examples, the avatar 405 has one or more characteristics of the avatars 315 and 317 described above with reference to FIG. 3.

As indicated in the overhead view 410 in FIG. 4D, the avatar 405 is positioned at seat D within the first spatial group. For example, the seat D of the plurality of seats 430 in FIG. 4C is selected because a spatial template is in use within the first spatial group as described above. Additionally, in some examples, the avatar 405 is positioned at seat D within the first spatial group based on the average forward direction 432 described above. For example, the seat D is (e.g., substantially) located in the direction of the average forward direction 432. Alternatively, in FIG. 4D, in the event that a spatial template is not in use, the placement location for the avatar 405 in the first spatial group is a predetermined distance from the origin 431 and in the direction of the average forward direction 432.

In some examples, as shown in the overhead view 412 in FIG. 4D, when the third electronic device 101c enters the multi-user communication session with the first electronic device 101a and the second electronic device 101b, the third electronic device 101c presents avatars corresponding to the users of the first electronic device 101a and the second electronic device 101b. For example, in the overhead view 412 in FIG. 4D, the third electronic device 101c displays (e.g., in a three-dimensional environment presented at the third electronic device 101c, similar to the three-dimensional environments 450A/450B) an avatar 411 corresponding to the second user 404 of the second electronic device 101b and an avatar 413 corresponding to the first user 402 of the first electronic device 101a. In some examples, the avatars 411 and 413 have one or more characteristics of the avatars 315 and 317 described above with reference to FIG. 3. In some examples, as indicated in the overhead view 412 in FIG. 4D, the third electronic device 101c displays the avatars 411 and 413 with respective orientations based on the orientations of the second electronic device 101b and the first electronic device 101a, respectively, and displays the avatars 411 and 413 at respective positions in the three-dimensional environment presented at the third electronic device 101c based on a spatial arrangement of the second electronic device 101b and the first electronic device 101a within the first spatial group (e.g., illustrated in the overhead view 410), as similarly discussed herein above.

In some examples, the above-described methods for selecting a placement location for the avatar corresponding to the third user 406 may similarly be utilized for selecting a placement location for virtual content that is shared within the multi-user communication session. For example, in FIG. 4E, rather than detecting an indication of a request to enter a multi-user communication session with the third electronic device 101c, the first electronic device 101a (e.g., or the second electronic device 101b) detects an input corresponding to a request to display shared content in the shared three-dimensional environment. As shown in FIG. 4E, the first electronic device 101a is optionally displaying user interface element 424 that is associated with a media player application (e.g., a movie player application). In some examples, the user interface element 424 includes one or more selectable options for sharing content (e.g., Movie A) in the multi-user communication session. For example, as shown in FIG. 4E, the user interface element 424 includes selectable option 426 that is selectable to share Movie A with all participants in the multi-user communication session (e.g., Everyone).

In FIG. 4E, while displaying the user interface element 424, the first electronic device 101a detects an input corresponding to a selection of the selectable option 426. For example, as shown in FIG. 4E, the first electronic device 101a detects an air pinch gesture performed by the hand 403 of the first user 402, optionally while the gaze 425 of the first user 402 is directed to the selectable option 426.

In some examples, in response to detecting the selection of the selectable option 426, the first electronic device 101a initiates a process to display a shared virtual object in the shared three-dimensional environment. In some examples, as mentioned above, the first electronic device 101a and the second electronic device 101b coordinate to select a placement location for the shared virtual object within the shared three-dimensional environment (e.g., based on the spatial arrangement of the first electronic device 101a and the second electronic device 101b in the first spatial group). Particularly, as described above, the first electronic device 101a and the second electronic device 101b select a placement location for the shared virtual object based on positions of the first electronic device 101a and the second electronic device 101b relative to the origin 431, an average forward direction of the first electronic device 101a and the second electronic device 101b, locations of physical objects in the physical environment 400 (e.g., such as the location of the stand 408), seat locations within a spatial template for the first spatial group, and/or locations of other virtual objects currently displayed in the shared three-dimensional environment (e.g., such as avatars or other application windows). Additionally, in some examples, the first electronic device 101a and the second electronic device 101b select a placement location for the shared virtual object based on object type. For example, the object type is based on an orientation of the shared virtual object, such as whether the object is a vertically oriented object or a horizontally oriented object, as discussed in more detail herein later.

In some examples, when the first electronic device 101a and the second electronic device 101b select a placement location for the shared virtual object in the shared three-dimensional environment (e.g., within the first spatial group), the first electronic device 101a and the second electronic device 101b display the shared virtual object at the selected placement location. For example, as shown in FIG. 4F, the shared virtual object is displayed as shared application window 435 in the shared three-dimensional environment (e.g., a media player user interface that is displaying Movie A). In some examples, as shown in the overhead view 410 in FIG. 4F, because the same methods above for identifying a placement location for an avatar are applied for identifying a placement location for a shared virtual object, the location of the shared application window 435 in the first spatial group is the same as the location of the avatar 405 in FIG. 4D. In some examples, the shared application window 435 has one or more characteristics of shared virtual object 310 discussed above with reference to FIG. 3.

In some examples, the above-described methods for selecting a placement location for the avatar corresponding to the third user 406 or the shared application window 435 may similarly be utilized for selecting placement locations for avatars corresponding to a group of remote users that joins the multi-user communication session. In FIG. 4G, the first electronic device 101a, the second electronic device 101b, and the third electronic device 101c are collocated in the physical environment 400, as similarly discussed above. For example, as shown in FIG. 4G, the first user 402, the second user 404, and the third user 406 are physically located in a same room. In some examples, the first electronic device 101a, the second electronic device 101b, and the third electronic device 101c are communicatively linked in a multi-user communication session. In the example of FIG. 4G, the first user 402, the second user 404, and the third user 406 constitute a group of local users (e.g., local to the physical environment 400).

In FIG. 4H, the first electronic device 101a, the second electronic device 101b, and the third electronic device 101c detect an indication of a request to join a multi-user communication session with a group of remote users. For example, as shown in overhead view 412 in FIG. 4H, a fourth user 414 of a fourth electronic device 101d, a fifth user 416 of a fifth electronic device 101e, and a sixth user 418 of a sixth electronic device 101f are collocated in physical environment 440, different from (e.g., separate from) the physical environment 400. In the example of FIG. 4H, the fourth user 414, the fifth user 416, and the sixth user 418 constitute a group of remote users relative to the group of local users discussed above (e.g., remote relative to the physical environment 400). In some examples, as similarly discussed above, when the first electronic device 101a, the second electronic device 101b, and the third electronic device 101c detect the indication of the request to enter the multi-user communication session with the fourth electronic device 101d, the fifth electronic device 101e, and the sixth electronic device 101f, a message element 420 is displayed at each electronic device (e.g., including the first option 421 and the second option 422).

In FIG. 4H, the first electronic device 101a (e.g., and the second electronic device 101b and the third electronic device 101c) detects an input indicating an acceptance of the request to enter the multi-user communication session with the group of remote users. For example, as similarly discussed above, the first electronic device 101a detects a selection of the first option 421 in the message element 420 displayed in the three-dimensional environment 450A.

In some examples, in response to detecting the input indicating the acceptance of the request to enter the multi-user communication session with the group of remote users, the first electronic device 101a (e.g., and the second electronic device 101b and the third electronic device 101c) initiate a process to display a plurality of avatars corresponding to the group of remote users in the shared three-dimensional environment. In some examples, because a group of remote users, rather than a single remote user, is entering the multi-user communication session with the first user 402, the second user 404, and the third user 406, the placement locations for the avatars corresponding to the group of remote users is determined based on a spatial arrangement of the remote users as well as being determined based on at least the spatial arrangement of the first user 402, the second user 404, and the third user 406 (e.g., as discussed previously above with reference to FIG. 4C). For example, as shown in FIG. 41, in the physical environment 440 in which the fourth user 414, the fifth user 416, and the sixth user 418 are located, the fourth electronic device 101d, the fifth electronic device 101e, and the sixth electronic device 101f are associated with a second spatial group 445, different from the first spatial group of the first electronic device 101a, the second electronic device 101b, and the third electronic device 101c. Additionally, in some examples, the fourth electronic device 101d, the fifth electronic device 101e, and the sixth electronic device 101f have a unique spatial arrangement within the second spatial group 445. For example, the second spatial group 445 is associated with a shared coordinate system/space having origin 431b (e.g., center) synchronized among the fourth electronic device 101d, the fifth electronic device 101e, and the sixth electronic device 101f, as similarly discussed previously herein. Accordingly, the fourth electronic device 101d is located at a first location within the second spatial group 445 (e.g., relative to the origin 431b), the fifth electronic device 101e is located at a second location within the second spatial group 445, and the sixth electronic device 101f is located at a third location within the second spatial group 445. Additionally, in some examples, the fourth electronic device 101d is separated from the fifth electronic device 101e by a first distance 444a, the fifth electronic device 101e is separated from the sixth electronic device 101f by a second distance 444b, and the sixth electronic device 101f is separated from the fourth electronic device 101d by a third distance 444c within the second spatial group 445.

Additionally, in some examples, the placement locations for the avatars corresponding to the group of remote users in the shared environment of the group of local users (e.g., the first user 402, the second user 404, and the third user 406) is determined based on an average forward direction of the electronic devices associated with the remote users. For example, as shown in the overhead view 412 in FIG. 4I, the fourth electronic device 101d has a first orientation in the physical environment 440, the fifth electronic device 101e has a second orientation in the physical environment 440, and the sixth electronic device 101f has a third orientation in the physical environment 440. Accordingly, as similarly discussed above, the fourth electronic device 101d, the fifth electronic device 101e, and the sixth electronic device 101f determine average forward direction 432b for the second spatial group 445.

In some examples, according to the methods discussed previously above, the first electronic device 101a, the second electronic device 101b, and the third electronic device 101c determine average forward direction 432a for the first spatial group based on the individual orientations of the electronic devices in the physical environment 400. Additionally, as previously discussed herein, the first electronic device 101a, the second electronic device 101b, and the third electronic device 101c identify locations of the electronic devices and/or distances between the electronic devices relative to origin 431a in the first spatial group.

In some examples, data corresponding to the locations of and/or distances between the electronic devices associated with the group of remote users within the second spatial group 445 is transferred to the first electronic device 101a, the second electronic device 101b, and/or the third electronic device 101c (e.g., directly from each electronic device or via a wireless server). Additionally or alternatively, in some examples, data corresponding to the orientations of and/or the average forward direction of the electronic devices associated with the group of remote users within the second spatial group 445 is transferred to the first electronic device 101a, the second electronic device 101b, and/or the third electronic device 101c (e.g., directly from each electronic device or via a wireless server). In some examples, the first electronic device 101a, the second electronic device 101b, and/or the third electronic device 101c utilize the above data to determine the placement locations for the avatars corresponding to the group of remote users in coordination with the spatial arrangement of the first spatial group and/or the average forward direction of the first electronic device 101a, the second electronic device 101b, and the third electronic device 101c.

In some examples, as shown in FIG. 4J, when the placement locations for the avatars corresponding to the group of remote users are determined by the first electronic device 101a, the second electronic device 101b, and/or the third electronic device 101c, the first electronic device 101a, the second electronic device 101b, and the third electronic device 101c display a plurality of avatars corresponding to the group of remote users in their respective three-dimensional environments. For example, as shown in FIG. 4J, the first electronic device 101a displays avatar 415 corresponding to the fourth user 414, avatar 417 corresponding to the fifth user 416, and avatar 419 corresponding to the sixth user 418 in the three-dimensional environment 450A. In some examples, the avatars 415, 417, and 419 have one or more characteristics of the avatars 317 and 319 discussed above with reference to FIG. 3.

In some examples, when the avatars 415, 417, and 419 corresponding to the group of remote users are displayed in the three-dimensional environment 450A at the first electronic device 101a (e.g., and in the respective three-dimensional environments at the second electronic device 101b and the third electronic device 101c), a spatial arrangement of the avatars 415, 417, and 419 within the three-dimensional environment 450A corresponds to the spatial arrangement of the fourth user 414, the fifth user 416, and the sixth user 418 within the second spatial group 445 in FIG. 41. For example, as shown in the overhead view 410 in FIG. 4J, the avatar 415 corresponding to the fourth user 414 is separated from the avatar 417 corresponding to the fifth user 416 by the first distance 444a (e.g., corresponding to the first distance 444a between the fourth electronic device 101d and the fifth electronic device 101e in the second spatial group 445 in FIG. 4I), the avatar 417 is separated from the avatar 419 corresponding to the sixth user 418 by the second distance 444b (e.g., corresponding to the second distance 444b between the fifth electronic device 101e and the sixth electronic device 101f in the second spatial group 445), and the avatar 419 is separated from the avatar 415 by the third distance 444c (e.g., corresponding to the third distance 444c between the sixth electronic device 101f and the fourth electronic device 101d in the second spatial group 445). Additionally, in some examples, as shown in the overhead view 410 and as similarly discussed above with reference to FIG. 3, when the avatars 415, 417, and 419 are displayed in the three-dimensional environment 450A (e.g., and in the respective three-dimensional environments at the second electronic device 101b and the third electronic device 101c), the avatars 415, 417, and 419 are displayed with respective orientations that are based on the orientations of the electronic devices associated with the group of remote users with which the avatars 415, 417, and 419 correspond. For example, the avatar 415 is displayed in the three-dimensional environment 450A with an orientation that corresponds to the orientation of the fourth electronic device 101d in the physical environment 440, the avatar 417 is displayed with an orientation that corresponds to the orientation of the fifth electronic device 101e, and the avatar 419 is displayed with an orientation that corresponds to the orientation of the sixth electronic device 101f, as illustrated in the overhead views 410 and 412 in FIG. 4J.

In some examples, when the avatars 415, 417, and 419 corresponding to the group of remote users are displayed in the three-dimensional environment 450A at the first electronic device 101a (e.g., and in the respective three-dimensional environments at the second electronic device 101b and the third electronic device 101c), positions of the avatars 415, 417, and 419 within the three-dimensional environment 450A are selected based on the average forward direction 432b of the electronic devices associated with the group of remote users. Particularly, as shown in the overhead view 410 in FIG. 4J, the average forward direction 432b is aligned to (e.g., is parallel to) the average forward direction 432a of the electronic devices associated with the group of local users. In some examples, the avatars 415, 417, and 419 corresponding to the group of remote users are positioned a predetermined distance from the viewpoints of the first electronic device 101a, the second electronic device 101b, and the third electronic device 101c (e.g., relative to the origin 431a of the first spatial group).

Additionally, in some examples, when the fourth electronic device 101d, the fifth electronic device 101e, and the sixth electronic device 101f enter the multi-user communication session with the first electronic device 101a, the second electronic device 101b, and the third electronic device 101c, the fourth electronic device 101d, the fifth electronic device 101e, and the sixth electronic device 101f generate and display avatars corresponding to the first user 402, the second user 404, and the third user 406 in the respective three-dimensional environments at the fourth electronic device 101d, the fifth electronic device 101e, and the sixth electronic device 101f. For example, as illustrated in the overhead view 412 in FIG. 4J, the fourth electronic device 101d, the fifth electronic device 101e, and the sixth electronic device 101f display an avatar 452 corresponding to the first user 402, an avatar 454 corresponding to the second user 404, and an avatar 456 corresponding to the third user 406. In some examples, the avatars 452, 454, and 456 have one or more characteristics of the avatars 317 and 319 discussed above with reference to FIG. 3.

In some examples, as similarly described above, when the avatars 452, 454, and 456 are displayed in the respective three-dimensional environments at the fourth electronic device 101d, the fifth electronic device 101e, and the sixth electronic device 101f, the avatars 452, 454, and 456 are displayed with a spatial arrangement that is based on the spatial arrangement of the first electronic device 101a, the second electronic device 101b, and the third electronic device 101c in the first spatial group discussed previously above. For example, as shown in the overhead view 412 in FIG. 4J, the avatar 452 corresponding to the first user 402 is separated from the avatar 454 corresponding to the second user 404 by a fourth distance 444d (e.g., corresponding to a distance between the first electronic device 101a and the second electronic device 101b within the first spatial group), the avatar 452 is separated from the avatar 456 corresponding to the third user 406 by a fifth distance 444c (e.g., corresponding to a distance between the first electronic device 101a and the third electronic device 101c), and the avatar 456 is separated from the avatar 454 by a sixth distance 444f (e.g., corresponding to a distance between the second electronic device 101b and the third electronic device 101c within the first spatial group). Additionally, as shown in the overhead view 412 and as similarly discussed above, the avatars 452, 454, and 456 are displayed at positions relative to the viewpoints of the fourth electronic device 101d, the fifth electronic device 101e, and the sixth electronic device 101f (e.g., relative to the origin 431b of the second spatial group) based on the average forward direction 432a of the first electronic device 101a, the second electronic device 101b, and the third electronic device 101c (e.g., by aligning the average forward direction 432a with the average forward direction 432b of the fourth electronic device 101d, the fifth electronic device 101e, and the sixth electronic device 101f). In some examples, as similarly discussed above, the fourth electronic device 101d, the fifth electronic device 101e, and the sixth electronic device 101f determine the placement locations for the avatars 452, 454, and 456 based on data provided by the first electronic device 101a, the second electronic device 101b, and/or the third electronic device 101c (e.g., related to the positions and/or orientations of the electronic devices).

Accordingly, as outlined above, providing systems and methods for displaying virtual objects (e.g., avatars and/or virtual content) in a shared three-dimensional environment while in a multi-user communication session advantageously enables collocated and non-collocated users to participate in the multi-user communication session and experience synchronized interaction with content and other users, thereby improving user-device interaction. Additionally, automatically determining location(s) at which to display the virtual objects (e.g., avatars and/or virtual content) in the shared three-dimensional environment reduces and/or helps avoid user input for manually selecting the location(s) in the shared three-dimensional environment, which helps conserve computing resources that would otherwise be consumed to respond to such user input, as another benefit. Attention is now directed toward additional examples of displaying virtual objects (e.g., avatars and/or virtual content) within a multi-user communication session that includes collocated and non-collocated users and electronic devices.

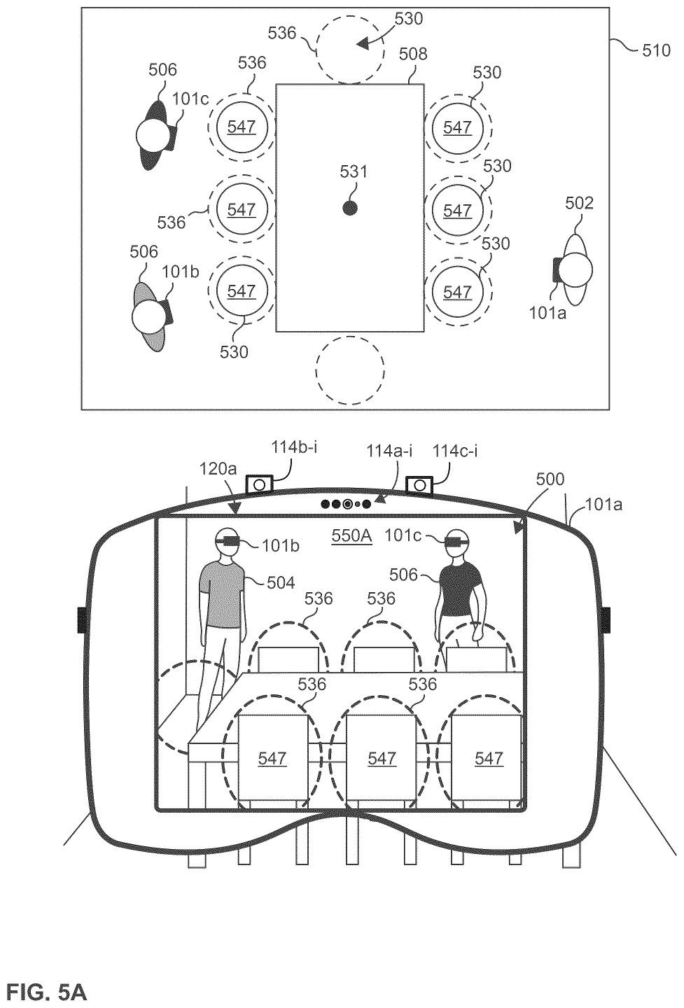

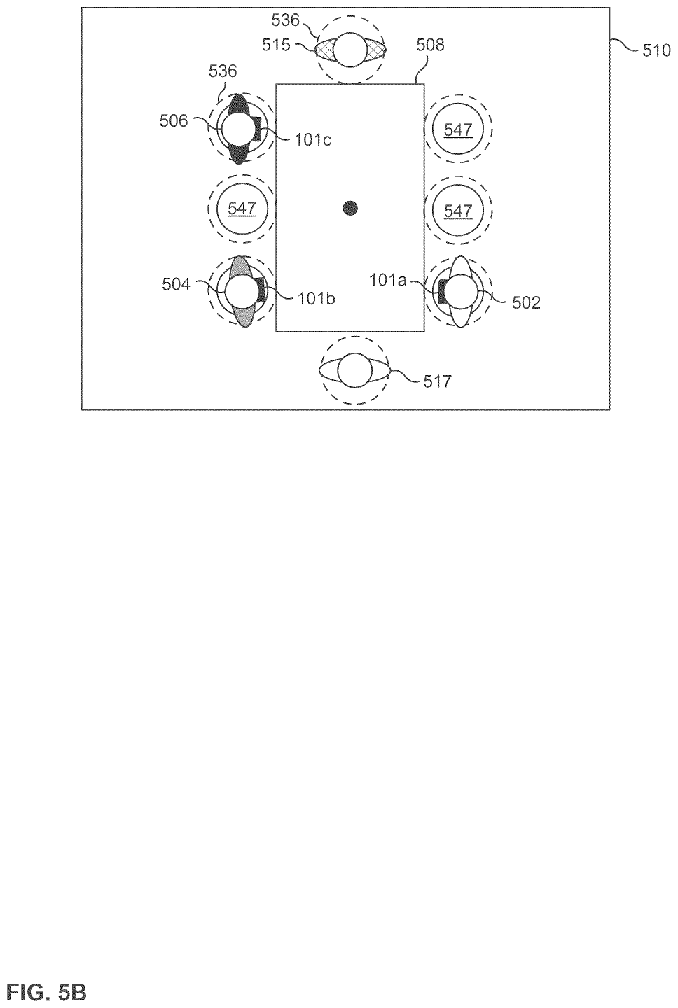

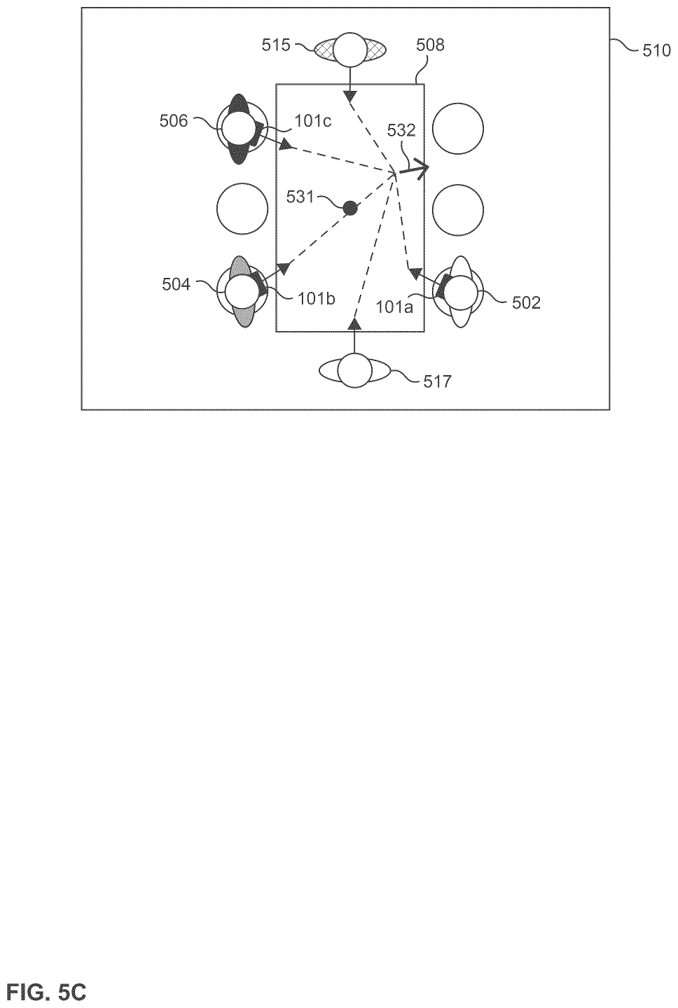

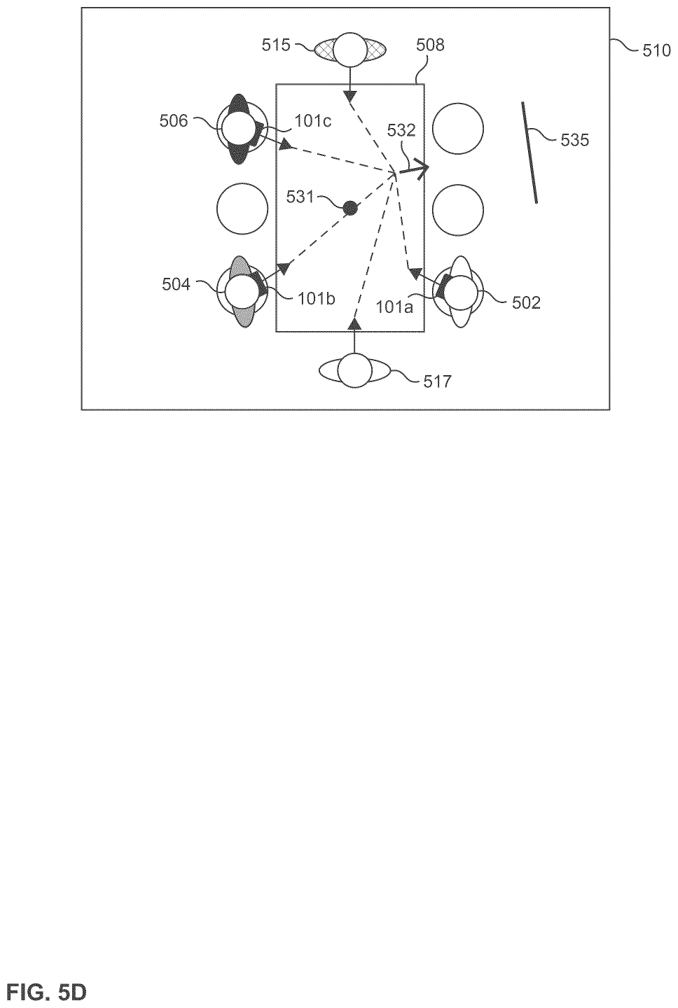

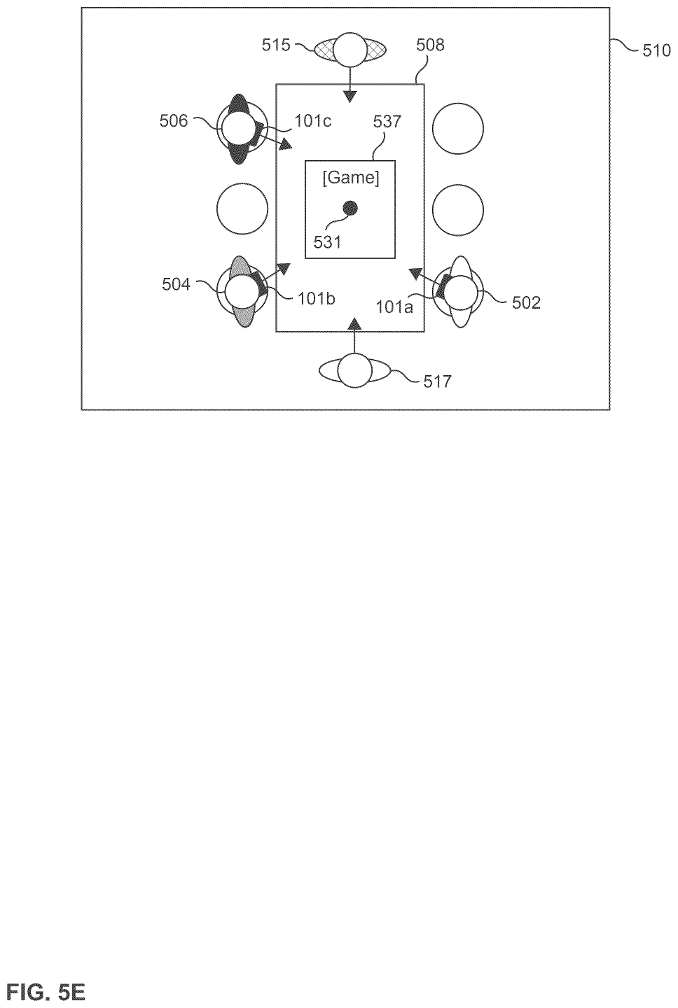

FIGS. 5A-5E illustrate examples of presenting content within a multi-user communication session that includes collocated and non-collocated users according to some examples of the disclosure. In FIG. 5A, first electronic device 101a (e.g., associated with first user 502), second electronic device 101b (e.g., associated with second user 504), and third electronic device 101c (e.g., associated with third user 506) are collocated in physical environment 500, as similarly discussed above. In some examples, the first user 502, the second user 504, and the third user 506 correspond to first user 402, second user 404, and third user 406, respectively, of FIGS. 4A-4J.

As shown in FIG. 5A, the first electronic device 101a is presenting (e.g., via display 120a) three-dimensional environment 550A. In FIG. 5A, as similarly discussed above, the three-dimensional environment 550A includes representations (e.g., passthrough representations or computer-generated representations) of the physical environment 500 of the first electronic device 101a. For example, as shown in overhead view 510 in FIG. 5A, the physical environment 500 corresponds to a room (e.g., a conference room) that includes table 508 and a plurality of chairs 547. Accordingly, as shown in FIG. 5A, the three-dimensional environment 550a presented using the first electronic device 101a includes representations of the table 508 and the plurality of chairs 547 (e.g., the table 508 and the plurality of chairs 547 are visible in a field of view of the first electronic device 101a). Additionally, as shown in FIG. 5A, the second user 504 (e.g., and the second electronic device 101b) and the third user 506 (e.g., and the third electronic device 101c) are currently visible in the three-dimensional environment 550A from a current viewpoint of the first electronic device 101a. In some examples, the three-dimensional environment 550A has one or more characteristics of three-dimensional environment 450A discussed above.

In the example of FIG. 5A, the first electronic device 101a (e.g., and/or the second electronic device 101b and the third electronic device 101c) has received an indication/input corresponding to a request to enter a multi-user communication session with a plurality of electronic devices, including the second electronic device 101b and the third electronic device 101c. In some examples, the indication/input has one or more characteristics of the indications/inputs discussed above with reference to FIGS. 4A-4J.

In some examples, as previously discussed herein, when the first electronic device 101a (e.g., and/or the second electronic device 101b and the third electronic device 101c) receives the indication of the request to enter the multi-user communication session, the first electronic device 101a, the second electronic device 101b, and the third electronic device 101c establish/form a spatial group corresponding to a shared three-dimensional environment within which virtual objects (e.g., avatars and/or virtual content) will be displayed (e.g., according to a shared/synchronized coordinate space, such as relative to (e.g., centered on) origin 531). In some examples, as mentioned previously above, the spatial group may be associated with a spatial template that indicates a plurality or number of seats which participants in the multi-user communication session can occupy. In some examples, the spatial template is determined based on one or more physical properties of the physical environment 500 in which the electronic devices 101a, 101b, and 101c are located. For example, the first electronic device 101a (e.g., and the second electronic device 101b and the third electronic device 101c) define the spatial template for the spatial group based on a size of the physical environment 500 and/or physical objects in the physical environment 500, such as the table 508 and the plurality of chairs 547. In the example of FIG. 5A, the spatial template is centered on the table 508 in the physical environment 500 (e.g., the origin 531 is positioned to be at a center of the table 508). Additionally, as indicated in the overhead view 510 in FIG. 5A, the plurality of seats 530 within the spatial template are positioned to correspond to the plurality of chairs 547 in the physical environment 500. In some examples, one or more of the plurality of seats 530 are selected based on open (e.g., unoccupied) areas of the physical environment 500 relative to the table 508, such as opposite ends of the table 508, as shown in the overhead view 510.

In some examples, when a spatial template that is based on the physical space surrounding the first electronic device 101a (e.g., and the second electronic device 101b and the third electronic device 101c) is utilized for arranging participants (e.g., remote and local users) in a multi-user communication session, the first electronic device 101a (e.g., and the second electronic device 101b and the third electronic device 101c) provides visual indications of the seats 530 within the spatial template. For example, because the seats 530 are defined to correspond to the chairs 547 and the ends of the table 508, as indicated in the overhead view 510, the first electronic device 101a displays visual indications 536 in the three-dimensional environment 550A at locations corresponding to the seats 530. In some examples, the visual indications 536 correspond to highlighting effects, glowing effects, sparkling effects, or other animation effects. The visual indications 536 optionally thus provide guidance and/or suggestion to the first user 502, the second user 504, and the third user 506 for arranging themselves at locations in the physical environment 500 that correspond to seats 530 within the spatial template of the spatial group for the multi-user communication session.

In FIG. 5A, the spatial group that is established among the first electronic device 101a, the second electronic device 101b, and the third electronic device 101c is a hybrid spatial group. For example, as previously discussed above, the multi-user communication session includes collocated and non-collocated electronic devices. For example, in FIG. 5B, a fourth electronic device (not shown) and a fifth electronic device (not shown) which are non-collocated with the first electronic device 101a, the second electronic device 101b, and the third electronic device 101c in the physical environment 500 have joined the multi-user communication session. Therefore, an avatar 515 corresponding to a fourth user of the fourth electronic device and an avatar 517 corresponding to a fifth user of the fifth electronic device are displayed in the shared three-dimensional environment. In some examples, the avatars 515 and 517 have one or more characteristics of avatars 315 and 317 described with reference to FIG. 3.

As shown in the overhead view 510 in FIG. 5B, because a spatial template is being utilized for the positioning of the participants (e.g., the users) in the multi-user communication session, the avatars 515 and 517 are displayed at locations in the shared three-dimensional environment corresponding to unoccupied seats (e.g., seats 530 in FIG. 5A). As shown in the overhead view 510 in FIG. 5B, the first user 502, the second user 504, and the third user 506 have positioned themselves at locations in the physical environment 500 that correspond to seats 530 within the spatial template, particularly within three of the chairs 547 of the table 508 in the physical environment. Accordingly, the avatars 515 and 517 are positioned at seats 530 that are not occupied by one of the first user 502, the second user 504, and the third user 506, as shown in FIG. 5B. For example, the avatars 515 and 517 are positioned at the seats 530 within the spatial group that are located on opposite ends of the table 508, as shown in the overhead view 510. Accordingly, the first user 502, the second user 504, the third user 506, the fourth user (e.g., represented by the avatar 515), and the fifth user (e.g., represented by the avatar 517) may communicate within the multi-user communication session (e.g., via their respective electronic devices) and each possess a unique viewpoint within the shared three-dimensional environment.

In some examples, as similarly discussed, while users are participating in a multi-user communication session, content can be shared within the shared three-dimensional environment, where the content is viewable by and/or interactive to the users in the multi-user communication session. For example, in FIG. 5C, an indication (e.g., an input) is detected by one of the electronic devices in the multi-user communication session corresponding to a request to share content within the shared three-dimensional environment. In some examples, the electronic devices within the multi-user communication session utilize the methods discussed previously above with reference to FIGS. 4A-4J to identify a placement location for the shared content in the shared three-dimensional environment. For example, as illustrated in the overhead view 510, an average forward direction 532 of the electronic devices and/or the users is determined based on the individual orientations of the electronic devices and/or the users, as previously discussed above. In FIG. 5C, because the multi-user communication session includes collocated and non-collocated electronic devices, the average forward direction 532 is determined based on both the orientations of the electronic devices that are collocated in the physical environment 500 (e.g., the first electronic device 101a, the second electronic device 101b, and the third electronic device 101c) and the orientations of the electronic devices that are non-collocated in the physical environment 500 (e.g., the fourth electronic device (the orientation of which is represented by the avatar 515) and the fifth electronic device (the orientation of which is represented by the avatar 517)). As previously discussed above, data corresponding to the orientations of the electronic devices are communicated among the electronic devices to coordinate the average forward direction 532 within the spatial group of the users in the multi-user communication session.

In some examples, a placement location for the shared content is selected to be in the direction of the average forward direction 532, as previously discussed above. For example, as shown in the overhead view 510 in FIG. 5D, virtual object 535 (e.g., an application window) is displayed in the shared three-dimensional environment at a location that is in the direction of (e.g., a location that intersects) the average forward direction 532. Additionally, in some examples, the virtual object 535 is displayed at a location that is a predetermined distance from the origin 531 in the shared three-dimensional environment. Additionally or alternatively, in some examples, the virtual object 535 is displayed based on one or more physical properties of the physical environment 500 of the collocated users. For example, in addition to or alternatively to being displayed at a location that is in the average forward direction 532, the virtual object 535 is displayed based on a physical surface of the physical environment 500 (e.g., the right side wall of the conference room in which the first user 502, the second user 504, and the third user 506 are located, in the overhead view 510). As shown in the overhead view 510 in FIG. 5D, the virtual object 535 is displayed relative to the right side wall, such as a predetermined distance from the right side wall. In some examples, the virtual object 535 is displayed to be aligned to the right side wall (e.g., the orientation of the virtual object 535 corresponds to the orientation of the right side wall and/or the virtual object 535 is anchored to a surface of the right side wall, though not explicitly shown in FIG. 5D).

In some examples, in addition to the placement location for the shared content being selected based on one or more physical properties of the physical environment 500, the placement location for the shared content may be selected based on one or more properties of the shared content itself. For example, as mentioned previously above, the one or more properties of the shared content include an orientation associated with the shared content. In FIG. 5D, the virtual object 535 is optionally a vertically oriented object. For example, a front-facing surface (e.g., on which or in which content is displayed) of the virtual object 535 is two-dimensional. In some examples, if the shared content is alternatively associated with a horizontally oriented object, an alternative physical surface in the physical environment 500 may be utilized to anchor and/or display the shared content. For example, as shown in the overhead view 510 in FIG. 5E, virtual object 537 corresponding to the shared content is alternatively displayed in the shared three-dimensional environment. In the example of FIG. 5E, the virtual object 537 is a horizontally oriented object (e.g., the virtual object 537 corresponds to a user interface of a game application, such as a virtual board game). Accordingly, as shown in the overhead view 510 in FIG. 5E, the virtual object 537 is displayed based on the physical surface of the table 508 in the physical environment 500 (e.g., the horizontal orientation of the virtual object 537 corresponds to the horizontal (e.g., flat) surface of the table 508). In some examples, as indicated in the overhead view 510 in FIG. 5E, the virtual object 537 may be centered on the origin 531, rather than necessarily positioned to be in the direction of the average forward direction 532 indicated in FIG. 5C.

Accordingly, as outlined above, providing systems and methods for displaying virtual content in a shared three-dimensional environment while in a multi-user communication session advantageously enables collocated and non-collocated users to participate in the multi-user communication session and experience synchronized interaction with the virtual content, thereby improving user-device interaction. Additionally, automatically determining location(s) at which to display the virtual content in the shared three-dimensional environment (e.g., based on one or more properties of a physical environment of the users or one or more properties of the virtual content) reduces and/or helps avoid user input for manually selecting the location(s) in the shared three-dimensional environment, which helps conserve computing resources that would otherwise be consumed to respond to such user input, as another benefit.

It is understood that the examples shown and described herein are merely exemplary and that additional and/or alternative elements may be provided within the three-dimensional environment for interacting with the illustrative content. It should be understood that the appearance, shape, form and size of each of the various user interface elements and objects shown and described herein are exemplary and that alternative appearances, shapes, forms and/or sizes may be provided. For example, the virtual objects representative of application windows (e.g., virtual objects 330, 435, 535 and 537) may be provided in an alternative shape than a rectangular shape, such as a circular shape, triangular shape, etc. In some examples, the various selectable options (e.g., options 421 and 422), user interface elements (e.g., message element 420 or user interface element 424), etc. described herein may be selected verbally via user verbal commands (e.g., “select option” verbal command). Additionally or alternatively, in some examples, the various options, user interface elements, control elements, etc. described herein may be selected and/or manipulated via user input received via one or more separate input devices in communication with the electronic device(s). For example, selection input may be received via physical input devices, such as a mouse, trackpad, keyboard, etc. in communication with the electronic device(s).

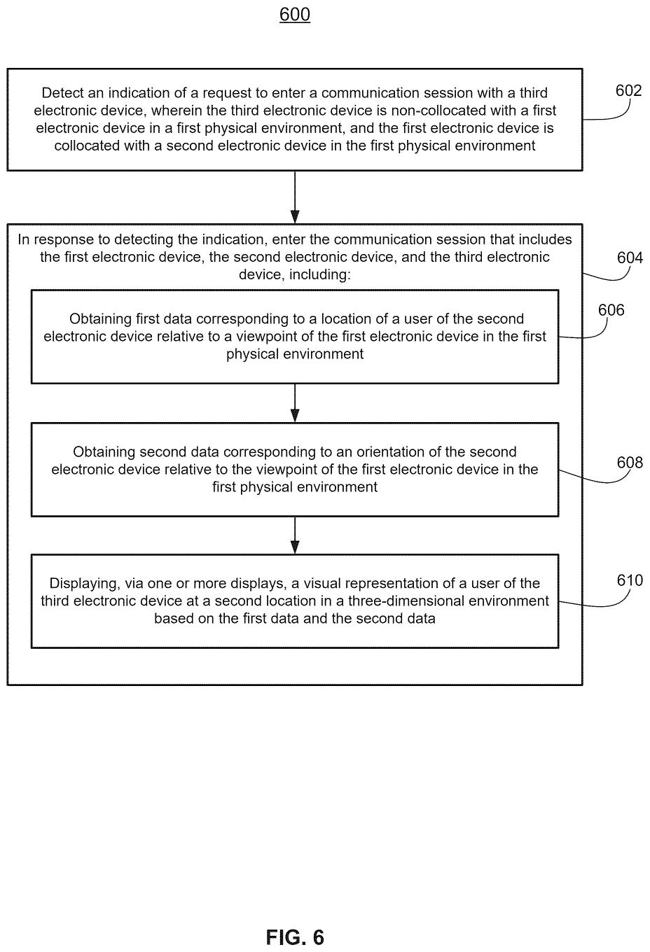

FIG. 6 illustrates a flow diagram illustrating an example process for establishing a multi-user communication session among a plurality of electronic devices in which at least a subset of the plurality of electronic device are non-collocated according to some examples of the disclosure. In some examples, process 600 begins at a first electronic device in communication with one or more displays and one or more input devices, wherein the first electronic device is collocated with a second electronic device in a first physical environment. In some examples, the first electronic device and the second electronic device are optionally a head-mounted display, respectively, similar or corresponding to device 200 of FIG. 2. As shown in FIG. 6, in some examples, at 602, the first electronic device detects an indication of a request to enter a communication session with a third electronic device, wherein the third electronic device is non-collocated in the first physical environment. For example, in FIG. 4B, the first electronic device 101a is displaying message element 420 that includes first option 421 that is selectable to enter a multi-user communication session with second electronic device 101b and third electronic device 101c.

In some examples, at 604, in response to detecting the indication, the first electronic device enters the communication session that includes the first electronic device, the second electronic device, and the third electronic device. For example, as described with reference to FIG. 4C, the first electronic device 101a initiates a process to determine a placement location for an avatar corresponding to a user of the third electronic device 101c. In some examples, at 606, the first electronic device obtains first data corresponding to a location of a user of the second electronic device relative to a viewpoint of the first electronic device in the first physical environment. For example, in the overhead view 410 in FIG. 4C, the first electronic device 101a identifies or determines a location of the second electronic device 101b relative to the viewpoint of the first electronic device 101a.

In some examples, at 608, the first electronic device obtains second data corresponding to an orientation of the second electronic device relative to the viewpoint of the first electronic device in the first physical environment. For example, in the overhead view 410 in FIG. 4C, the first electronic device 101a identifies or determines an orientation of the second electronic device 101b, such as to determine an average forward direction 432 of the first electronic device 101a and the second electronic device 101b. In some examples, at 610, the first electronic device displays, via the one or more displays, a visual representation of a user of the third electronic device at a second location in a computer-generated environment based on the first data and the second data. For example, as shown in FIG. 4D, the first electronic device 101a displays avatar 405 corresponding to the user of the third electronic device 101c in the three-dimensional environment 450A.

It is understood that process 600 is an example and that more, fewer, or different operations can be performed in the same or in a different order. Additionally, the operations in process 600 described above are, optionally, implemented by running one or more functional modules in an information processing apparatus such as general-purpose processors (e.g., as described with respect to FIG. 2) or application specific chips, and/or by other components of FIG. 2.

Therefore, according to the above, some examples of the disclosure are directed to a method comprising, at a first electronic device in communication with one or more displays and one or more input devices, wherein the first electronic device is collocated with a second electronic device in a first physical environment, detecting an indication of a request to enter a communication session with a third electronic device, wherein the third electronic device is non-collocated in the first physical environment, and in response to detecting the indication, entering the communication session that includes the first electronic device, the second electronic device, and the third electronic device, including: obtaining first data corresponding to a location of a user of the second electronic device relative to a viewpoint of the first electronic device in the first physical environment; obtaining second data corresponding to an orientation of the second electronic device relative to the viewpoint of the first electronic device in the first physical environment; and displaying, via the one or more displays, a visual representation of a user of the third electronic device at a second location in a computer-generated environment, the second location determined based on the first data and the second data.

Additionally or alternatively, in some examples, the first electronic device being collocated with the second electronic device in the first physical environment is in accordance with a determination that the second electronic device is within a threshold distance of the first electronic device in the first physical environment. Additionally or alternatively, in some examples, the third electronic device being non-collocated with the first electronic device in the first physical environment is in accordance with a determination that the third electronic device is more than the threshold distance of the first electronic device in the first physical environment. Additionally or alternatively, in some examples, the second electronic device being collocated with the first electronic device in the first physical environment is in accordance with a determination that the second electronic device is located in a field of view of the first electronic device. Additionally or alternatively, in some examples, the third electronic device being non- collocated with the first electronic device in the first physical environment is in accordance with a determination that the third electronic device is located in a second physical environment, different from the first physical environment. Additionally or alternatively, in some examples, the first data corresponding to the location of the user of the second electronic device relative to the viewpoint of the first electronic device in the first physical environment and the second data corresponding to the orientation of the second electronic device relative to the viewpoint of the first electronic device in the first physical environment are obtained based on one or more images of the first physical environment captured via one or more cameras of the first electronic device. Additionally or alternatively, in some examples, obtaining the first data corresponding to the location of the user of the second electronic device relative to the viewpoint of the first electronic device in the first physical environment includes receiving the first data from the second electronic device, and obtaining second data corresponding to an orientation of the second electronic device relative to the viewpoint of the first electronic device in the first physical environment includes receiving the second data from the second electronic device.

Additionally or alternatively, in some examples, after entering the communication session that includes the first electronic device, the second electronic device, and the third electronic device, the user of the second electronic device is visible in a field of view of the first electronic device. Additionally or alternatively, in some examples, entering the communication session that includes the first electronic device, the second electronic device, and the third electronic device further includes determining an average orientation of electronic devices in the communication session based on the orientation of the second electronic device and an orientation of the first electronic device in the first physical environment. Additionally or alternatively, in some examples, the second location is further determined based on the average orientation of the electronic devices. Additionally or alternatively, in some examples, the second location is further determined based on one or more physical characteristics of the first physical environment. Additionally or alternatively, in some examples, the one or more physical characteristics of the first physical environment include one or more locations of one or more physical objects in the first physical environment. Additionally or alternatively, in some examples, the second location is further determined based on one or more characteristics of the computer-generated environment. Additionally or alternatively, in some examples, the one or more characteristics of the computer-generated environment include one or more locations of one or more virtual objects in the computer-generated environment.

Additionally or alternatively, in some examples, prior to detecting the indication of the request to enter the communication session, the first electronic device is in communication with a fourth electronic device, the first electronic device being collocated with the fourth electronic device in the first physical environment, after entering the communication session, the communication session includes the first electronic device, the second electronic device, the third electronic device, and the fourth electronic device, and entering the communication session further comprises: obtaining third data corresponding to a location of a user of the fourth electronic device relative to the viewpoint of the first electronic device in the first physical environment; and obtaining fourth data corresponding to an orientation of the fourth electronic device relative to the viewpoint of the first electronic device in the first physical environment, wherein the second location is determined based on the first data, the second data, the third data, and the fourth data. Additionally or alternatively, in some examples, the method further comprises: detecting a second indication of a request to add a fourth electronic device to the communication session, wherein the fourth electronic device is non-collocated in the first physical environment; and in response to detecting the second indication, displaying, via the one or more displays, a visual representation of a user of the fourth electronic device at a third location, different from the second location, in the computer-generated environment, the third location based on the first data, the second data, and the second location at which the visual representation of the user of the third electronic device is displayed. Additionally or alternatively, in some examples, the method further comprises: after entering the communication session, detecting a third indication of a request to display shared content in the computer-generated environment; and in response to detecting the third indication, displaying, via the one or more displays, a first object corresponding to the shared content at a fourth location, different from the second location, in the computer-generated environment, the fourth location based on the first data, the second data, and the second location at which the visual representation of the user of the third electronic device is displayed. Additionally or alternatively, in some examples, in accordance with a determination that the shared content is a first type of content, the fourth location is a first respective location in the computer-generated environment, and in accordance with a determination that the shared content is a second type of content, different from the first type of content, the fourth location is a second respective location, different from the first respective location, in the computer-generated environment.

Additionally or alternatively, in some examples, the indication of the request to enter the communication session with the third electronic device corresponds to an indication of a request to enter the communication session with the third electronic device and a fifth electronic device, wherein the fifth electronic device is collocated with the third electronic device in a second physical environment, different from the first physical environment. Additionally or alternatively, in some examples, the method further comprises, in response to detecting the indication, displaying, via the one or more displays, a visual representation of a user of the fifth electronic device at a fifth location, different from the second location, in the computer-generated environment, the fifth location based on the first data and the second data. Additionally or alternatively, in some examples, the third electronic device is separated from the fifth electronic device by a first distance in the second physical environment, and the fifth location is separated from the second location by the first distance in the computer-generated environment. Additionally or alternatively, in some examples, the method further comprises, in response to detecting the indication: determining a first average orientation of electronic devices in the first physical environment based on the orientation of the second electronic device and an orientation of the first electronic device; and determining a second average orientation of electronic devices in the second physical environment based on an orientation of the third electronic device and an orientation of the fifth electronic device; wherein the second location and the fifth location are further determined based on aligning the first average orientation and the second average orientation. Additionally or alternatively, in some examples, detecting the indication of the request to enter the communication session with the third electronic device includes detecting, via the one or more input devices, an input corresponding to a request to initiate a communication session with the second electronic device and the third electronic device. Additionally or alternatively, in some examples, the indication of the request to enter the communication session with the third electronic device corresponds to user input detected by the second electronic device or the third electronic device for initiating a communication session with the first electronic device and the third electronic device or the first electronic device and the second electronic device.

Some examples of the disclosure are directed to a first electronic device comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of a first electronic device, cause the first electronic device to perform any of the above methods.

Some examples of the disclosure are directed to a first electronic device, comprising one or more processors, memory, and means for performing any of the above methods.

Some examples of the disclosure are directed to an information processing apparatus for use in a first electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at a first electronic device in communication with one or more displays and one or more input devices, wherein the first electronic device is collocated with a second electronic device in a first physical environment:
detecting an indication of a request to enter a communication session with a third electronic device, wherein the third electronic device is non-collocated in the first physical environment; and
in response to detecting the indication, entering the communication session that includes the first electronic device, the second electronic device, and the third electronic device, including:
obtaining first data corresponding to a location of a user of the second electronic device relative to a viewpoint of the first electronic device in the first physical environment;
obtaining second data corresponding to an orientation of the second electronic device relative to the viewpoint of the first electronic device in the first physical environment; and
displaying, via the one or more displays, a visual representation of a user of the third electronic device at a second location in a three-dimensional environment, the second location determined based on the first data and the second data.

2. The method of claim 1, wherein:
the first electronic device being collocated with the second electronic device in the first physical environment is in accordance with a determination that the second electronic device is within a threshold distance of the first electronic device in the first physical environment; and
the third electronic device being non-collocated with the first electronic device in the first physical environment is in accordance with a determination that the third electronic device is more than the threshold distance of the first electronic device in the first physical environment.

3. The method of claim 1, wherein the second electronic device being collocated with the first electronic device in the first physical environment is in accordance with a determination that the second electronic device is located in a field of view of the first electronic device.

4. The method of claim 1, wherein:
the first data corresponding to the location of the user of the second electronic device relative to the viewpoint of the first electronic device in the first physical environment and the second data corresponding to the orientation of the second electronic device relative to the viewpoint of the first electronic device in the first physical environment are obtained based on one or more images of the first physical environment captured via one or more cameras of the first electronic device.

5. The method of claim 1, wherein:
obtaining the first data corresponding to the location of the user of the second electronic device relative to the viewpoint of the first electronic device in the first physical environment includes receiving the first data from the second electronic device; and
obtaining second data corresponding to an orientation of the second electronic device relative to the viewpoint of the first electronic device in the first physical environment includes receiving the second data from the second electronic device.

6. The method of claim 1, wherein:
prior to detecting the indication of the request to enter the communication session, the first electronic device is in communication with a fourth electronic device, the first electronic device being collocated with the fourth electronic device in the first physical environment;
after entering the communication session, the communication session includes the first electronic device, the second electronic device, the third electronic device, and the fourth electronic device; and
entering the communication session further comprises:
obtaining third data corresponding to a location of a user of the fourth electronic device relative to the viewpoint of the first electronic device in the first physical environment; and
obtaining fourth data corresponding to an orientation of the fourth electronic device relative to the viewpoint of the first electronic device in the first physical environment; and
the second location is determined based on the first data, the second data, the third data, and the fourth data.

7. The method of claim 1, further comprising:
after entering the communication session, detecting a third indication of a request to display shared content in the three-dimensional environment; and
in response to detecting the third indication:
displaying, via the one or more displays, a first object corresponding to the shared content at a fourth location, different from the second location, in the three-dimensional environment, the fourth location based on the first data, the second data, and the second location at which the visual representation of the user of the third electronic device is displayed.

8. The method of claim 1, wherein the indication of the request to enter the communication session with the third electronic device corresponds to an indication of a request to enter the communication session with the third electronic device and a fifth electronic device, wherein the fifth electronic device is collocated with the third electronic device in a second physical environment, different from the first physical environment, the method further comprising:
in response to detecting the indication:
displaying, via the one or more displays, a visual representation of a user of the fifth electronic device at a fifth location, different from the second location, in the three-dimensional environment, the fifth location based on the first data and the second data.

9. A first electronic device comprising:
one or more processors;
memory; and
one or more programs stored in the memory and configured to be executed by the one or more processors, the one or more programs including instructions for performing a method comprising:
while the first electronic device is collocated with a second electronic device in a first physical environment, detecting an indication of a request to enter a communication session with a third electronic device, wherein the third electronic device is non-collocated in the first physical environment; and
in response to detecting the indication, entering the communication session that includes the first electronic device, the second electronic device, and the third electronic device, including:
obtaining first data corresponding to a location of a user of the second electronic device relative to a viewpoint of the first electronic device in the first physical environment;
obtaining second data corresponding to an orientation of the second electronic device relative to the viewpoint of the first electronic device in the first physical environment; and
displaying, via one or more displays, a visual representation of a user of the third electronic device at a second location in a three-dimensional environment, the second location determined based on the first data and the second data.

10. The first electronic device of claim 9, wherein:
the first electronic device being collocated with the second electronic device in the first physical environment is in accordance with a determination that the second electronic device is within a threshold distance of the first electronic device in the first physical environment; and
the third electronic device being non-collocated with the first electronic device in the first physical environment is in accordance with a determination that the third electronic device is more than the threshold distance of the first electronic device in the first physical environment.

11. The first electronic device of claim 9, wherein the second electronic device being collocated with the first electronic device in the first physical environment is in accordance with a determination that the second electronic device is located in a field of view of the first electronic device.

12. The first electronic device of claim 9, wherein:
the first data corresponding to the location of the user of the second electronic device relative to the viewpoint of the first electronic device in the first physical environment and the second data corresponding to the orientation of the second electronic device relative to the viewpoint of the first electronic device in the first physical environment are obtained based on one or more images of the first physical environment captured via one or more cameras of the first electronic device.

13. The first electronic device of claim 9, wherein:
obtaining the first data corresponding to the location of the user of the second electronic device relative to the viewpoint of the first electronic device in the first physical environment includes receiving the first data from the second electronic device; and
obtaining second data corresponding to an orientation of the second electronic device relative to the viewpoint of the first electronic device in the first physical environment includes receiving the second data from the second electronic device.

14. The first electronic device of claim 9, wherein:
prior to detecting the indication of the request to enter the communication session, the first electronic device is in communication with a fourth electronic device, the first electronic device being collocated with the fourth electronic device in the first physical environment;
after entering the communication session, the communication session includes the first electronic device, the second electronic device, the third electronic device, and the fourth electronic device; and
entering the communication session further comprises:
obtaining third data corresponding to a location of a user of the fourth electronic device relative to the viewpoint of the first electronic device in the first physical environment; and
obtaining fourth data corresponding to an orientation of the fourth electronic device relative to the viewpoint of the first electronic device in the first physical environment; and
the second location is determined based on the first data, the second data, the third data, and the fourth data.

15. The first electronic device of claim 9, wherein the method further comprises:
after entering the communication session, detecting a third indication of a request to display shared content in the three-dimensional environment; and
in response to detecting the third indication:
displaying, via the one or more displays, a first object corresponding to the shared content at a fourth location, different from the second location, in the three-dimensional environment, the fourth location based on the first data, the second data, and the second location at which the visual representation of the user of the third electronic device is displayed.

16. The first electronic device of claim 9, wherein the indication of the request to enter the communication session with the third electronic device corresponds to an indication of a request to enter the communication session with the third electronic device and a fifth electronic device, wherein the fifth electronic device is collocated with the third electronic device in a second physical environment, different from the first physical environment, the method further comprising:
in response to detecting the indication:
displaying, via the one or more displays, a visual representation of a user of the fifth electronic device at a fifth location, different from the second location, in the three-dimensional environment, the fifth location based on the first data and the second data.

17. A non-transitory computer readable storage medium storing one or more programs, the one or more programs comprising instructions, which when executed by one or more processors of a first electronic device, cause the first electronic device to perform a method comprising:
while the first electronic device is collocated with a second electronic device in a first physical environment, detecting an indication of a request to enter a communication session with a third electronic device, wherein the third electronic device is non-collocated in the first physical environment; and
in response to detecting the indication, entering the communication session that includes the first electronic device, the second electronic device, and the third electronic device, including:
obtaining first data corresponding to a location of a user of the second electronic device relative to a viewpoint of the first electronic device in the first physical environment;
obtaining second data corresponding to an orientation of the second electronic device relative to the viewpoint of the first electronic device in the first physical environment; and
displaying, via one or more displays, a visual representation of a user of the third electronic device at a second location in a three-dimensional environment, the second location determined based on the first data and the second data.

18. The non-transitory computer readable storage medium of claim 17, wherein:
the first electronic device being collocated with the second electronic device in the first physical environment is in accordance with a determination that the second electronic device is within a threshold distance of the first electronic device in the first physical environment; and
the third electronic device being non-collocated with the first electronic device in the first physical environment is in accordance with a determination that the third electronic device is more than the threshold distance of the first electronic device in the first physical environment.

19. The non-transitory computer readable storage medium of claim 17, wherein the second electronic device being collocated with the first electronic device in the first physical environment is in accordance with a determination that the second electronic device is located in a field of view of the first electronic device.

20. The non-transitory computer readable storage medium of claim 17, wherein:
the first data corresponding to the location of the user of the second electronic device relative to the viewpoint of the first electronic device in the first physical environment and the second data corresponding to the orientation of the second electronic device relative to the viewpoint of the first electronic device in the first physical environment are obtained based on one or more images of the first physical environment captured via one or more cameras of the first electronic device.

21. The non-transitory computer readable storage medium of claim 17, wherein:
obtaining the first data corresponding to the location of the user of the second electronic device relative to the viewpoint of the first electronic device in the first physical environment includes receiving the first data from the second electronic device; and
obtaining second data corresponding to an orientation of the second electronic device relative to the viewpoint of the first electronic device in the first physical environment includes receiving the second data from the second electronic device.

22. The non-transitory computer readable storage medium of claim 17, wherein:
prior to detecting the indication of the request to enter the communication session, the first electronic device is in communication with a fourth electronic device, the first electronic device being collocated with the fourth electronic device in the first physical environment;
after entering the communication session, the communication session includes the first electronic device, the second electronic device, the third electronic device, and the fourth electronic device; and
entering the communication session further comprises:
obtaining third data corresponding to a location of a user of the fourth electronic device relative to the viewpoint of the first electronic device in the first physical environment; and
obtaining fourth data corresponding to an orientation of the fourth electronic device relative to the viewpoint of the first electronic device in the first physical environment; and
the second location is determined based on the first data, the second data, the third data, and the fourth data.

23. The non-transitory computer readable storage medium of claim 17, wherein the method further comprises:
after entering the communication session, detecting a third indication of a request to display shared content in the three-dimensional environment; and
in response to detecting the third indication:
displaying, via the one or more displays, a first object corresponding to the shared content at a fourth location, different from the second location, in the three-dimensional environment, the fourth location based on the first data, the second data, and the second location at which the visual representation of the user of the third electronic device is displayed.

24. The non-transitory computer readable storage medium of claim 17, wherein the indication of the request to enter the communication session with the third electronic device corresponds to an indication of a request to enter the communication session with the third electronic device and a fifth electronic device, wherein the fifth electronic device is collocated with the third electronic device in a second physical environment, different from the first physical environment, the method further comprising:
in response to detecting the indication:
displaying, via the one or more displays, a visual representation of a user of the fifth electronic device at a fifth location, different from the second location, in the three-dimensional environment, the fifth location based on the first data and the second data.
